(19) United States
(12) Patent Application Publication
(10) Pub. No.: US 2025/0355153 A1
(43) Pub. Date: Nov. 20, 2025

(54) POLARIZER AND DISPLAY DEVICE

(71) Applicant: Shenzhen China Star Optoelectronics Semiconductor Display Technology Co., Ltd., Shenzhen (CN)

(72) Inventors: Hanming LI, Shenzhen (CN); Ji LI, Shenzhen (CN); Fang TAN, Shenzhen (CN)

(73) Assignee: Shenzhen China Star Optoelectronics Semiconductor Display Technology Co., Ltd., Shenzhen (CN)

(21) Appl. No.: 18/759,903

(22) Filed: Jun. 30, 2024

(30) Foreign Application Priority Data
May 14, 2024 (CN) 202421054425.6

(51) Int. Cl. G02B 5/30; G02F 1/1335

(52) U.S. Cl. CPC G02B 5/3008; G02F 1/133528

(57) ABSTRACT

The disclosure provides a polarizer and a display device. The polarizer includes a polarizing layer, a first protective layer, an adhesive layer between the polarizing layer and the first protective layer, and adjusting particles dispersed in the adhesive layer; the adjusting particles include first type of adjusting particles, second type of adjusting particles, or both of them, a length-diameter ratio of the first type of adjusting particles is greater than or equal to 5 and less than or equal to 50, and a length-diameter ratio of the second type of adjusting particles is greater than or equal to 1 and less than 5.

This application claims priority to and the benefit of Chinese Patent Application No. 202421054425.6, filed on May 14, 2024. The disclosure of the aforementioned application is incorporated herein by reference in its entirety.

### TECHNICAL FIELD

The disclosure relates to the field of display, and in particular, to a polarizer and a display device.

### BACKGROUND

With the development of display technology, the demand for high-quality display devices is increasing. The existing display devices may experience deviations in display color and other aspects as the viewing display angle gradually increases caused by the polarizers. There is still room for improvement in the display device as to its display quality when viewed at different viewing angles.

Therefore, it is necessary to provide a polarizer and a display device to solve the above-mentioned technical problems.

### SUMMARY

In some embodiments, the disclosure provides a polarizer including:
a polarizing layer;
a first protective layer disposed on a side of the polarizing layer;
an adhesive layer disposed between the polarizing layer and the first protective layer; and
adjusting particles dispersed in the adhesive layer;
in which the adjusting particles include:
first type adjusting particles, in which one of the first type of adjusting particles includes a plurality of first cross-sectional surfaces, each of the first cross-sectional surfaces has a first inscribed circle, and a ratio of a length of a major axis of one of the first type of adjusting particles to a diameter of the first inscribed circle with a largest diameter among a plurality of the first inscribed circles is greater than or equal to 5 and less than or equal to 50; and/or

second type of adjusting particles, in which one of the second type of adjusting particles includes a plurality of second cross-sectional surfaces, each of the second cross-sectional surfaces has a second inscribed circle, and a ratio of a length of a major axis of one of the second type of adjusting particles to a diameter of the second inscribed circle with a largest diameter among a plurality of the second inscribed circles is greater than or equal to 1 and less than 5.

Embodiments of the disclosure further provide a display device including the polarizer as discussed above.

### BRIEF DESCRIPTION OF THE DRAWINGS

In order to explain technical solutions in the embodiments of the disclosure more clearly, the following introduces the drawings used in description of the embodiments. Apparently, the drawings in the following description are only used to illustrate some embodiments of the disclosure. For ordinary skilled in the art, other drawings can be obtained from these drawings without paying creative effort.

FIG. 1 is a first schematic structural diagram of a polarizer provided in some embodiments of the disclosure.

FIG. 2 is a second schematic structural diagram of the polarizer provided in some embodiments of the disclosure.

FIG. 3 is a third schematic structural diagram of the polarizer provided in some embodiments of the disclosure.

FIG. 4 is a fourth schematic structural diagram of the polarizer provided in some embodiments of the disclosure.

FIG. 5 is a fifth schematic structural diagram of the polarizer provided in some embodiments of the disclosure.

FIG. 6 is a sixth schematic structural diagram of the polarizer provided in some embodiments of the disclosure.

FIG. 7 is a seventh schematic structural diagram of the polarizer provided in some embodiments of the disclosure.

FIG. 8 is an eighth schematic structural diagram of the polarizer provided in some embodiments of the disclosure.

FIG. 9 is a ninth schematic structural diagram of the polarizer provided in some embodiments of the disclosure.

FIG. 10 is a tenth schematic structural diagram of the polarizer provided in some embodiments of the disclosure.

FIG. 11 is an eleventh schematic structural diagram of the polarizer provided in some embodiments of the disclosure.

FIG. 12 is a twelfth schematic structural diagram of the polarizer provided in some embodiments of the disclosure.

FIG. 13 is a schematic structural diagram of a display device provided in some embodiments of the disclosure.

### DETAILED DESCRIPTION

In combination with the drawings in the embodiments of the disclosure, technical solutions in the embodiments of the disclosure will be described clearly and completely. Apparently, the described embodiments are only part of the embodiments of the disclosure, not all of them. Based on the embodiments of the disclosure, all other embodiments obtained by those skilled in the art without creative effort belong to the scope of the disclosure. In addition, it should be understood that specific embodiments described herein are only used to explain and illustrate the disclosure and are not intended to limit the disclosure. In the disclosure, the directional terms, such as “up” and “down”, generally refer to upward and downward directions of the device, respectively, in actual use or working state, or in particular directions in the drawings; and terms “inside” and “outside” are relative to the contour of the devices shown in the drawings, unless otherwise described.

At present, the existing display devices may experience deviations in display color and other aspects as the viewing display angle gradually increases caused by the polarizers. There is still room for improvement in the display device as to its display quality when viewed at different viewing angles.

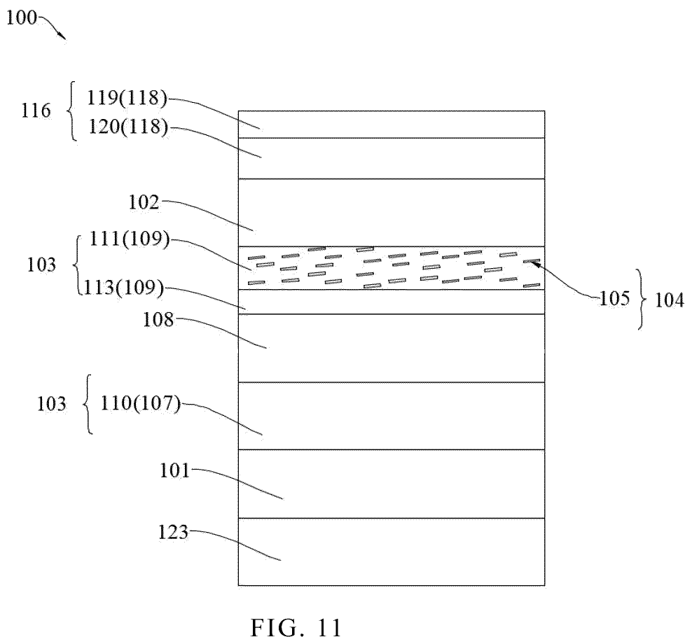

As illustrated in FIGS. 1 to 12, in some embodiments, the disclosure provides a polarizer 100 including:
a polarizing layer 101;
a first protective layer 102 disposed on a side of the polarizing layer 101;
an adhesive layer 103 is disposed between the polarizing layer 101 and the first protective layer 102; and
adjusting particles 104 dispersed in the adhesive layer 103;
in which the adjusting particles 104 include:
first type of adjusting particles 105, in which one of the first type of adjusting particles 105 includes a plurality of first cross-sectional surfaces, each of the first cross-sectional surfaces has a first inscribed circle, and a ratio of a length of a major axis of one of the first type of adjusting particles 105 to a diameter of the first inscribed circle with a largest diameter among a plurality of the first inscribed circles is greater than or equal to 5 and less than or equal to 50; and/or
second type of adjusting particles 106, in which one of the second type of adjusting particles 106 includes a plurality of second cross-sectional surfaces, each of the second cross-sectional surfaces has a second inscribed circle, and a ratio of a length of a major axis of one of the second type of adjusting particles 106 to a diameter of the second inscribed circle with a largest diameter among a plurality of the second inscribed circles is greater than or equal to 1 and less than 5.

The embodiments of the disclosure improve the color viewing angle and contrast of the polarizer 100 by dispersing the adjusting particles 104 in the adhesive layer 103 between the polarizing layer 101 and the first protective layer 102, thereby enhancing the display quality of the display device including the polarizer 100.

The technical solutions of the disclosure are described in conjunction with specific embodiments in the following.

As illustrated in FIGS. 1 to 7, in some embodiments, the adhesive layer 103 includes a first adhesive layer 107 disposed between the first protective layer 102 and the polarizing layer 101, and the adjusting particles 104 are dispersed in the first adhesive layer 107. In some embodiments, the adhesive layer 103 may only include the first adhesive layer 107.

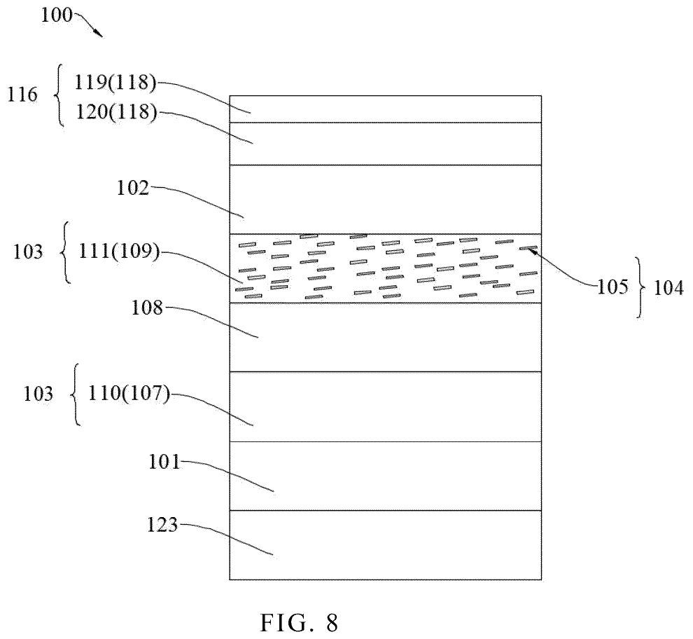

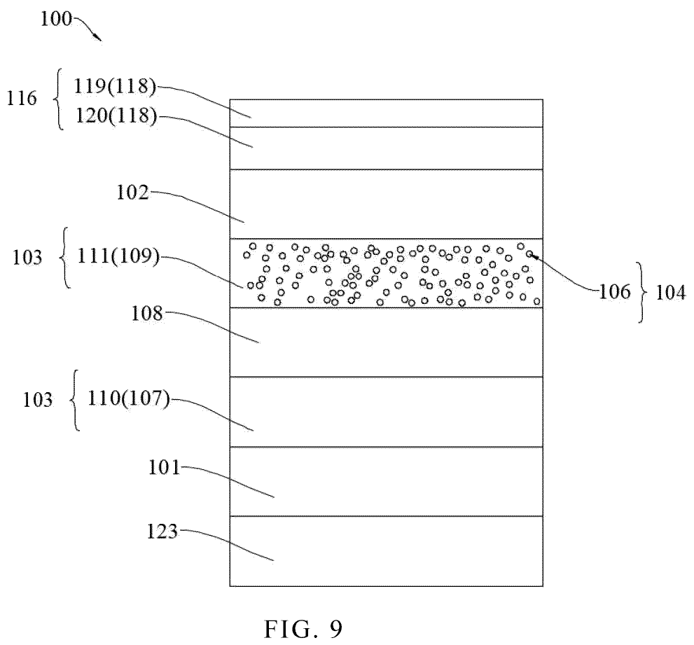

As illustrated in FIGS. 8 to 12, in some embodiments, the polarizer 100 further includes a second protective layer 108 disposed between the first protective layer 102 and the polarizing layer 101. The adhesive layer 103 further includes a second adhesive layer 109. The first adhesive layer 107 is disposed between the second protective layer 108 and the polarizing layer 101, and the second adhesive layer 109 is disposed between the first protective layer 102 and the second protective layer 108. The adjusting particles 104 are dispersed in the first adhesive layer 107, the second adhesive layer 109, or both of them.

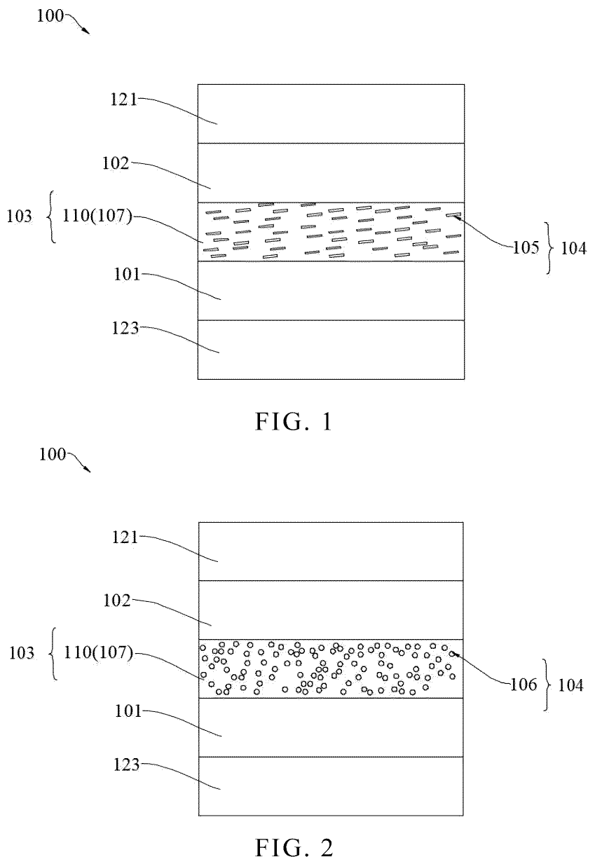

As illustrated in FIG. 1 and FIG. 2, in some embodiments, the first adhesive layer 107 consists of one adhesive sub-layer. For example, the first adhesive layer 107 only includes a first adhesive sub-layer 110, the adjusting particles 104 in the first adhesive layer 107 are dispersed in the first adhesive sub-layer 110, and a thickness of the first adhesive sub-layer 110 is equal to a thickness of the first adhesive layer 107. The thickness of the first adhesive layer 107 (the first adhesive sub-layer 110) is greater than or equal to 20 microns and less than or equal to 40 microns, and the adjusting particles 104 are dispersed in the first adhesive sub-layer 110 with the thickness of 20 microns to 40 microns. For example, the thickness of the first adhesive layer 107 (the first adhesive sub-layer 110) may be 21 microns, 24 microns, 25 microns, 26 microns, 28 microns, 30 microns, 32 microns, 35 microns, 36 microns, 38 microns, or the like.

As illustrated in FIG. 8 and FIG. 9, in some embodiments, the second adhesive layer 109 consists of one adhesive sub-layer. For example, the second adhesive layer 109 only includes a second adhesive sub-layer 111, the adjusting particles 104 are dispersed in the first adhesive sub-layer 110, the second adhesive sub-layer 111, or both of them, and a thickness of the second adhesive sub-layer 111 is equal to a thickness of the second adhesive layer 109. The thickness of the second adhesive layer 109 (the second adhesive sub-layer 111) is greater than or equal to 20 microns and less than or equal to 40 microns, and the adjusting particles 104 are dispersed in the second adhesive sub-layer 111 with the thickness of 20 microns to 40 microns. For example, the thickness of the second adhesive layer 109 (the second adhesive sub-layer 111) may be 21 microns, 24 microns, 25 microns, 26 microns, 28 microns, 30 microns, 32 microns, 35 microns, 36 microns, 38 microns, or the like.

In some embodiments, when the first adhesive layer 107 consists of one adhesive sub-layer, a material of the first adhesive layer 107 may be selected from a pressure-sensitive adhesive, a water-based adhesive, or a UV-curing adhesive. When the second adhesive layer 109 consists of one adhesive sub-layer, a material of the second adhesive layer 109 may be selected from a pressure-sensitive adhesive, a water-based adhesive, or a UV-curing adhesive. The pressure-sensitive adhesive may be a heat-curing pressure-sensitive adhesive. The pressure-sensitive adhesive, the water-based adhesive, and the UV-curing adhesive are commercially available adhesives.

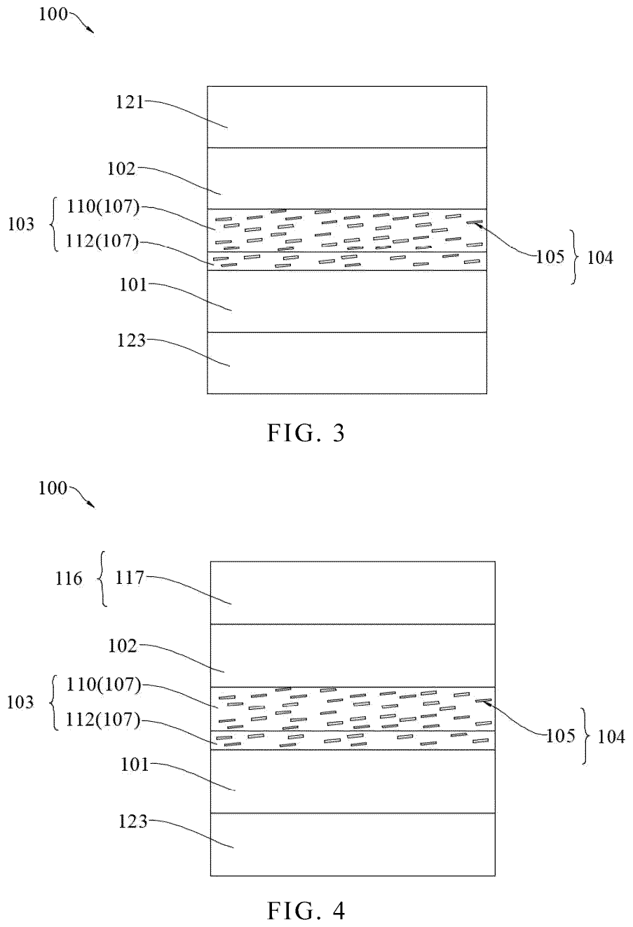

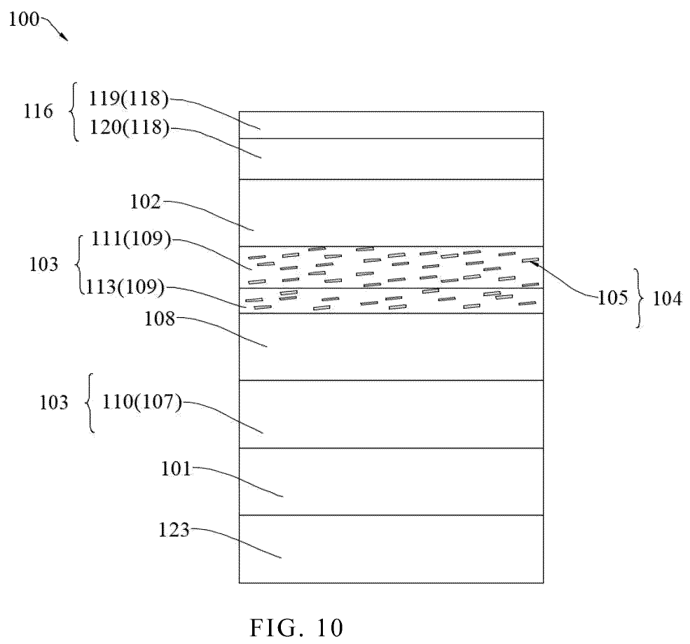

As illustrated in FIGS. 3 to 7, in some embodiments, the first adhesive layer 107 includes the first adhesive sub-layer 110 and a third adhesive sub-layer 112. The third adhesive sub-layer 112 is disposed at a side of the first adhesive sub-layer 110 close to the polarizing layer 101, and the adjusting particles 104 in the first adhesive layer 107 are dispersed at least in the first adhesive sub-layer 110; and/or, as illustrated in FIGS. 10 to 12, the second adhesive layer 109 includes the second adhesive sub-layer 111 and a fourth adhesive sub-layer 113. The fourth adhesive sub-layer 113 is disposed at a side of the second adhesive sub-layer 111 close to the polarizing layer 101, and the adjusting particles 104 in the second adhesive layer 109 are dispersed at least in the second adhesive sub-layer 111.

In some embodiments, a material of the first adhesive sub-layer 110, a material of the second adhesive sub-layer 111, a material of the third adhesive sub-layer 112, and a material of the fourth adhesive sub-layer 113 are independently selected from a pressure-sensitive adhesive, a water-based adhesive, or a UV-curing adhesive. The pressure-sensitive adhesive, the water-based adhesive, and the UV-curing adhesive are commercially available adhesives. For example, the pressure-sensitive adhesive may be an acrylic resin, the water-based adhesive may be an adhesive material such as polyvinyl alcohol, and the UV-curing adhesive may be an adhesive material such as an acrylic resin or an epoxy resin.

In some embodiments, the material of the first adhesive sub-layer 110 is a pressure-sensitive adhesive. When the material of the third adhesive sub-layer 112 is an adhesive material selected from a water-based adhesive or a UV-curing adhesive, the adjusting particles 104 may be dispersed in the first adhesive sub-layer 110 and not dispersed in the third adhesive sub-layer 112. When the first adhesive sub-layer 110 is made from the pressure-sensitive adhesive having a longr chain resin, it is easier for the adjusting particles 104 to be arranged along a long chain direction of the resin during the process of forming the first adhesive sub-layer 110 (such as coating process), so that the arrangement of the adjusting particles 104 in the first adhesive sub-layer 110 is more regular, thereby enhancing the improvement effect of the adjusting particles 104 on the color viewing angle, the contrast, and other optical properties of the polarizer 100. In some embodiments, the material of the second adhesive sub-layer 111 is a pressure-sensitive adhesive. When the material of the fourth adhesive sub-layer 113 is an adhesive material selected from a water-based adhesive or a UV-curing adhesive, the adjusting particles 104 can be dispersed in the second adhesive sub-layer 111 and not dispersed in the fourth adhesive sub-layer 113.

As illustrated in FIGS. 3 to 5, in some embodiments, the adjusting particles 104 in the first adhesive layer 107 are also dispersed in the third adhesive sub-layer 112. When the adjusting particles 104 are dispersed in the third adhesive sub-layer 112, the material of the third adhesive sub-layer 112 is preferably a pressure-sensitive adhesive, which is conducive to the regular arrangement of the adjusting particles 104 in the third adhesive sub-layer 112, enhancing the improvement effect of the adjusting particles 104 on the color viewing angle, the contrast, and other optical properties of the polarizer 100. In some embodiments, as illustrated in FIGS. 10 to 12, the adjusting particles 104 in the second adhesive layer 109 are also dispersed in the fourth adhesive sub-layer 113. When the adjusting particles 104 are dispersed in the fourth adhesive sub-layer 113, the material of the fourth adhesive sub-layer 113 is preferably a pressure-sensitive adhesive.

In some embodiments, when the adjusting particles 104 are dispersed in the first adhesive sub-layer 110 and the third adhesive sub-layer 112, because the first adhesive sub-layer 110 and the third adhesive sub-layer 112 are formed in different steps, the thickness of each of the first adhesive sub-layer 110 and the third adhesive sub-layer 112 is less than the thickness of the first adhesive layer 107 that consists of one adhesive sub-layer, which is conducive to reducing an angle formed between each of the adjusting particles 104 and a first plane, further enhancing the improvement effect of the adjusting particles 104 on the color viewing angle, the contrast, and other optical properties of the polarizer 100. The first plane is a plane where the polarizing layer 101 is located. In some embodiments, when the adjusting particles 104 are dispersed in the second adhesive sub-layer 111 and the fourth adhesive sub-layer 113, because the second adhesive sub-layer 111 and the fourth adhesive sub-layer 113 are formed in different steps, the thickness of each of the second adhesive sub-layer 111 and the fourth adhesive sub-layer 113 is less than the thickness of the second adhesive layer 109 that consists of one adhesive sub-layer, which is conducive to reducing the angle between each of the adjusting particles 104 and the first plane, further enhancing the improvement effect of the adjusting particles 104 on the color viewing angle, the contrast, and other optical properties of the polarizer 100.

In some embodiments, the thickness of the first adhesive sub-layer 110 is greater than or equal to the thickness of the third adhesive sub-layer 112; and/or, the thickness of the second adhesive sub-layer 111 is greater than or equal to the thickness of the fourth adhesive sub-layer 113.

In some embodiments, when the adjusting particles 104 in the first adhesive layer 107 are dispersed in the first adhesive sub-layer 110 and not dispersed in the third adhesive sub-layer 112, the thickness of the first adhesive sub-layer 110 is greater than the thickness of the third adhesive sub-layer 112. The third adhesive sub-layer 112 is independently in contact with the polarizing layer 101 and the first adhesive sub-layer 110. That is, the third adhesive sub-layer 112 is disposed between the first adhesive sub-layer 110 and the polarizing layer 101. Therefore, the third adhesive sub-layer 112 plays a reinforcing role between the first adhesive sub-layer 110 and the polarizing layer 101, which is conducive to improving the adhesive performance of the first adhesive layer 107.

In some embodiments, when the adjusting particles 104 in the second adhesive layer 109 are dispersed in the second adhesive sub-layer 111 and not dispersed in the fourth adhesive sub-layer 113, the thickness of the second adhesive sub-layer 111 is greater than the thickness of the fourth adhesive sub-layer 113. The fourth adhesive sub-layer 113 is independently in contact with the second protective layer 108 and the second adhesive sub-layer 111. That is, the fourth adhesive sub-layer 113 is disposed between the second adhesive sub-layer 111 and the polarizing layer 101. Therefore, the fourth adhesive sub-layer 113 plays a reinforcing role between the second adhesive sub-layer 111 and the polarizing layer 101, which is conducive to improving the adhesive performance of the second adhesive layer 109.

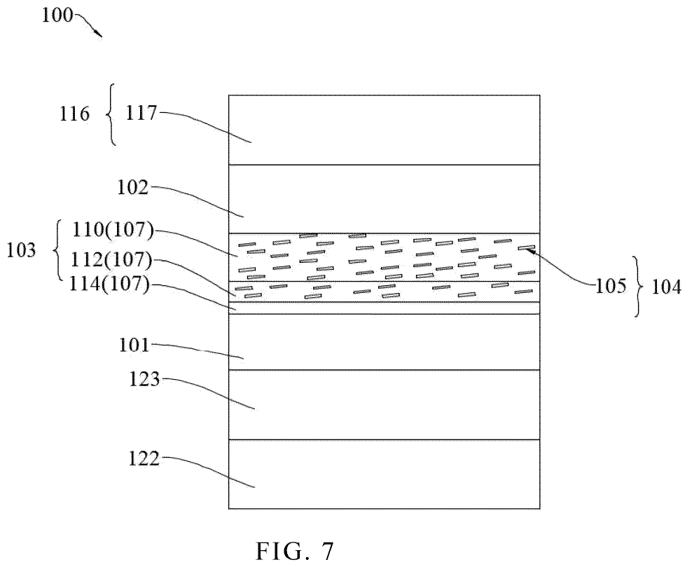

As illustrated in FIG. 7, in some embodiments, when the adjusting particles 104 in the first adhesive layer 107 are dispersed in the first adhesive sub-layer 110 and the third adhesive sub-layer 112, the first adhesive layer 107 further includes a fifth adhesive sub-layer 114 disposed at a side of the third adhesive sub-layer 112 close to the polarizing layer 101, and the adjusting particles 104 are dispersed outside the fifth adhesive sub-layer 114. When the first adhesive layer 107 is disposed between the first protective layer 102 and the polarizing layer 101, the fifth adhesive sub-layer 114 is in contact with the polarizing layer 101 and the third adhesive sub-layer 112. Alternatively, when the first adhesive layer 107 is disposed between the second protective layer 108 and the polarizing layer 101, the fifth adhesive sub-layer 114 is respectively in contact with the polarizing layer 101 and the third adhesive sub-layer 112. Therefore, the fifth adhesive sub-layer 114 is disposed between the polarizing layer 101 and the third adhesive sub-layer 112, and plays a reinforcing role and improves the adhesive performance of the first adhesive layer 107.

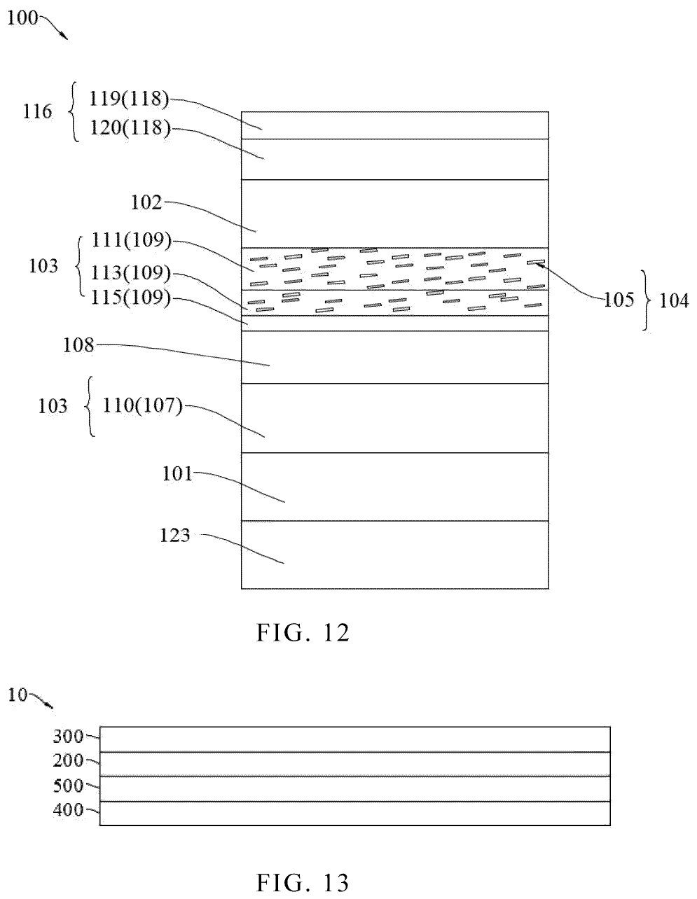

As illustrated in FIG. 12, in some embodiments, the adjusting particles 104 in the second adhesive layer 109 are dispersed in the second adhesive sub-layer 111 and the fourth adhesive sub-layer 113, the second adhesive layer 109 further includes a sixth adhesive sub-layer 115 disposed at a side of the fourth adhesive sub-layer 113 close to the polarizing layer 101, and the adjusting particles 104 are dispersed outside the sixth adhesive sub-layer 115. When the sixth adhesive sub-layer 115 is respectively in contact with the second protective layer 108 and the fourth adhesive sub-layer 113, that is, the sixth adhesive sub-layer 115 is disposed between the polarizing layer 101 and the fourth adhesive sub-layer 113, playing a reinforcing role and improving the adhesive performance of the second adhesive layer 109.

In some embodiments, a material of the fifth adhesive sub-layer 114 and a material of the sixth adhesive sub-layer 115 are independently selected from a pressure-sensitive adhesive, a water-based adhesive, or a UV-curing adhesive. The pressure-sensitive adhesive, the water-based adhesive, and the UV-curing adhesive are commercially available adhesives.

In some embodiments, when the adjusting particles 104 are dispersed in the first adhesive sub-layer 110 and the third adhesive sub-layer 112, the thickness of the first adhesive sub-layer 110 may be greater than or equal to the thickness of the third adhesive sub-layer 112.

In some embodiments, when the adjusting particles 104 are dispersed in the second adhesive sub-layer 111 and the fourth adhesive sub-layer 113, the thickness of the second adhesive sub-layer 111 may be greater than or equal to the thickness of the fourth adhesive sub-layer 113.

In some embodiments, a ratio of the thickness of the first adhesive sub-layer 110 to the thickness of the third adhesive sub-layer 112 is greater than or equal to 1:1 and less than or equal to 40:1, for example, 1.5:1, 2:1, 3:1, 4:1, 5:1, 6:1, 7:1, 8:1, 10:1, 14:1, 15:1, 16:1, 19:1, 20:1, 24:1, 25:1, 29:1, 30:1, 34:1, 35:1, 39:1, or the like.

In some embodiments, when the third adhesive sub-layer 112 is disposed between the first adhesive sub-layer 110 and the polarizing layer 101, and the adjusting particles 104 are dispersed in the first adhesive sub-layer 110 and not dispersed in the third adhesive sub-layer 112, the third adhesive sub-layer 112 plays a role in enhancing the adhesive effect. The thickness of the third adhesive sub-layer 112 is less than or equal to 10 microns, for example, 1 micron, 2 microns, 3 microns, 4 microns, 5 microns, 6 microns, 7 microns, 8 microns, 9 microns, or the like.

In some embodiments, when the fourth adhesive sub-layer 113 is disposed between the second adhesive sub-layer 111 and the second protective layer 108, and the adjusting particles 104 are dispersed in the second adhesive sub-layer 111 and not dispersed in the fourth adhesive sub-layer 113, the fourth adhesive sub-layer 113 plays a role in enhancing the adhesive effect. The thickness of the fourth adhesive sub-layer 113 is less than or equal to 10 microns, for example, 1 micron, 2 microns, 3 microns, 4 microns, 5 microns, 6 microns, 7 microns, 8 microns, 9 microns, or the like.

In some embodiments, when the adjusting particles 104 are dispersed in the first adhesive sub-layer 110, and the adjusting particles 104 in the first adhesive layer 107 are dispersed only in the first adhesive sub-layer 110, the thickness of the first adhesive sub-layer 110 is greater than or equal to 20 microns and less than or equal to 40 microns, for example, 21 microns, 22 microns, 24 microns, 25 microns, 26 microns, 27 microns, 28 microns, 30 microns, 31 microns, 32 microns, 33 microns, 35 microns, 36 microns, 37 microns, 39 microns, or the like, to facilitate the formation of the angle between each of the adjusting particles 104 and the first plane in an appropriate range, enhancing the improvement effect of the adjusting particles 104 on the color viewing angle, the contrast, and other optical properties of the polarizer 100.

In some embodiments, when the adjusting particles 104 are dispersed in the second adhesive sub-layer 111, and the adjusting particles 104 in the second adhesive layer 109 are dispersed only in the second adhesive sub-layer 111, the thickness of the second adhesive sub-layer 111 is greater than or equal to 20 microns and less than or equal to 40 microns, for example, 21 microns, 22 microns, 24 microns, 25 microns, 26 microns, 27 microns, 28 microns, 30 microns, 31 microns, 32 microns, 33 microns, 35 microns, 36 microns, 37 microns, 39 microns, or the like, to facilitate the angle formed between each of the adjusting particles 104 and the first plane in an appropriate range, to facilitate the angle formed between each of the adjusting particles 104 and the first plane in an appropriate range, enhancing the improvement effect of the adjusting particles 104 on the color viewing angle, the contrast, and other optical properties of the polarizer 100.

In some embodiments, when the adjusting particles 104 are dispersed in the first adhesive sub-layer 110 and the third adhesive sub-layer 112, the adjusting particles 104 in the first adhesive layer 107 can be dispersed only in the first adhesive sub-layer 110 and the third adhesive sub-layer 112. The total thicknesses of the first adhesive sub-layer 110 and the third adhesive sub-layer 112 is greater than or equal to 20 microns and less than or equal to 40 microns, for example, 21 microns, 22 microns, 24 microns, 25 microns, 26 microns, 27 microns. 28 microns, 30 microns, 31 microns, 32 microns, 33 microns, 35 microns, 36 microns, 37 microns, 39 microns, or the like, so as to facilitate the adjusting particles 104 being dispersed in the layers with an appropriate thickness range, which reduces the angle formed between each of the adjusting particles 104 and the first plane, and further enhances the improvement effect of the adjusting particles 104 on the color viewing angle, the contrast, and other optical properties of the polarizer 100.

In some embodiments, when the adjusting particles 104 are dispersed in the second adhesive sub-layer 111 and the fourth adhesive sub-layer 113, the adjusting particles 104 in the second adhesive layer 109 can be dispersed only in the second adhesive sub-layer 111 and the fourth adhesive sub-layer 113. The total thicknesses of the second adhesive sub-layer 111 and the fourth adhesive sub-layer 113 is greater than or equal to 20 microns and less than or equal to 40 microns, for example, 21 microns, 22 microns, and 24 microns. 25 microns, 26 microns, 27 microns, 28 microns, 30 microns, 31 microns, 32 microns, 33 microns, 35 microns, 36 microns, 37 microns, 39 microns, or the like, to facilitate the adjusting particles 104 being dispersed in the layers with an appropriate thickness range, which reduces the angle formed between each of the adjusting particles 104 and the first plane, and further enhances the improvement effect of the adjusting particles 104 on the color viewing angle, the contrast, and other optical properties of the polarizer 100.

In some embodiments, the first adhesive layer 107 further includes at least one adhesive sub-layer disposed between the first adhesive sub-layer 110 and the third adhesive sub-layer 112. The adjusting particles 104 are dispersed in the first adhesive sub-layer 110 and the adhesive sub-layer between the first adhesive sub-layer 110 and the third adhesive sub-layer 112, and not dispersed in the third adhesive sub-layer 112. Alternatively, the adjusting particles 104 in the first adhesive layer 107 are dispersed in the first adhesive sub-layer 110, the third adhesive sub-layer 112, and the adhesive sub-layer between the first adhesive sub-layer 110 and the third adhesive sub-layer 112.

In some embodiments, the second adhesive layer 109 further includes at least one adhesive sub-layer disposed between the second adhesive sub-layer 111 and the fourth adhesive sub-layer 113. The adjusting particles 104 are dispersed in the second adhesive sub-layer 111 and the adhesive sub-layer between the second adhesive sub-layer 111 and the fourth adhesive sub-layer 113, and not dispersed in the fourth adhesive sub-layer 113. Alternatively, the adjusting particles 104 in the second adhesive layer 109 are dispersed in the second adhesive sub-layer 111, the fourth adhesive sub-layer 113, and the adhesive sub-layer between the second adhesive sub-layer 111 and the fourth adhesive sub-layer 113.

In some embodiments, when the adjusting particles 104 are dispersed in the first adhesive sub-layer 110 and the adhesive sub-layer between the first adhesive sub-layer 110 and the third adhesive sub-layer 112, and not dispersed in the third adhesive sub-layer 112, the total thickness of the first adhesive sub-layer 110 and a thickness of the adhesive sub-layer between the first adhesive sub-layer 110 and the third adhesive sub-layer 112 is greater than or equal to 20 microns and less than or equal to 40 microns, for example, 21 microns, 22 microns, 24 microns, 25 microns, 26 microns, 27 microns, 28 microns, 30 microns, 31 microns, 32 microns. Microns, 33 microns, 35 microns, 36 microns, 37 microns, 39 microns, or the like. Exemplarily, the first adhesive layer 107 further includes a seventh adhesive sub-layer disposed between the first adhesive sub-layer 110 and the third adhesive sub-layer 112, the adjusting particles 104 are dispersed in the first adhesive sub-layer 110 and the seventh adhesive sub-layer, and the total thickness of the first adhesive sub-layer 110 and a thickness of the seventh adhesive sub-layer is greater than or equal to 20 microns and less than or equal to 40 microns.

In some embodiments, when the adjusting particles 104 are dispersed in the second adhesive sub-layer 111 and the adhesive sub-layer between the second adhesive sub-layer 111 and the fourth adhesive sub-layer 113, and not dispersed in the fourth adhesive sub-layer 113, the total thickness of the second adhesive sub-layer 111 and a thickness of the adhesive sub-layer between the second adhesive sub-layer 111 and the fourth adhesive sub-layer 113 is greater than or equal to 20 microns and less than or equal to 40 microns, for example, 21 microns, 22 microns, 24 microns, 25 microns, 26 microns, 27 microns, 28 microns. 30 microns, 31 microns, 32 microns, 33 microns, 35 microns, 36 microns, 37 microns, 39 microns, or the like. Exemplarily, the second adhesive layer 109 further includes an eighth adhesive sub-layer disposed between the second adhesive sub-layer 111 and the fourth adhesive sub-layer 113, the adjusting particles 104 are dispersed in the second adhesive sub-layer 111 and the eighth adhesive sub-layer, and the total thickness of the second adhesive sub-layer 111 and a thickness of the eighth adhesive sub-layer is greater than or equal to 20 microns and less than or equal to 40 microns.

In some embodiments, when the adjusting particles 104 in the first adhesive layer 107 are dispersed in the first adhesive sub-layer 110, the third adhesive sub-layer 112, and the adhesive sub-layer between the first adhesive sub-layer 110 and the third adhesive sub-layer 112, the total thickness of the first adhesive sub-layer 110, the third adhesive sub-layer 112, and the adhesive sub-layer between the first adhesive sub-layer 110 and the third adhesive sub-layer 112 is greater than or equal to 20 microns and less than or equal to 40 microns, for example, 21 microns, 22 microns, 24 microns, 25 microns, 26 microns, 27 microns, and 28 microns. 30 microns, 31 microns, 32 microns, 33 microns, 35 microns, 36 microns, 37 microns, 39 microns, or the like. Exemplarily, the first adhesive layer 107 further includes the seventh adhesive sub-layer, the adjusting particles 104 are dispersed in the first adhesive sub-layer 110, the third adhesive sub-layer 112, and the seventh adhesive sub-layer, and the total thicknesses of the first adhesive sub-layer 110, the third adhesive sub-layer 112, and the seventh adhesive sub-layer is greater than or equal to 20 microns and less than or equal to 40 microns.

In some embodiments, when the adjusting particles 104 in the second adhesive layer 109 are dispersed in the second adhesive sub-layer 111, the fourth adhesive sub-layer 113, and the adhesive sub-layer between the second adhesive sub-layer 111 and the fourth adhesive sub-layer 113, the total thicknesses of the second adhesive sub-layer 111, the fourth adhesive sub-layer 113, the adhesive sub-layer between the second adhesive sub-layer 111 and the fourth adhesive sub-layer 113 is greater than or equal to 20 microns and less than or equal to 40 microns, for example, 21 microns, 22 microns, 24 microns, 25 microns, 26 microns, 27 microns, 28 microns, 30 microns, 31 microns, 32 microns, 33 microns, 35 microns, 36 microns, 37 microns, 39 microns, or the like. Exemplarily, the second adhesive layer 109 further includes the eighth adhesive sub-layer, the adjusting particles 104 are dispersed in the second adhesive sub-layer 111, the fourth adhesive sub-layer 113, and the eighth adhesive sub-layer, and the total thicknesses of the second adhesive sub-layer 111, the fourth adhesive sub-layer 113, and the eighth adhesive sub-layer is greater than or equal to 20 microns and less than or equal to 40 microns.

In some embodiments, when the adjusting particles 104 are also dispersed in the adhesive sub-layer between the first adhesive sub-layer 110 and the third adhesive sub-layer 112 (for example, the seventh adhesive sub-layer), a material of the adhesive sub-layer between the first adhesive sub-layer 110 and the third adhesive sub-layer 112 is selected from a pressure-sensitive adhesive, a water-based adhesive, or a UV-curing adhesive; and/or, when the adjusting particles 104 are also dispersed in the adhesive sub-layer between the second adhesive sub-layer 111 and the fourth adhesive sub-layer 113 (for example, the eighth adhesive sub-layer), a material of the adhesive sub-layer between the second adhesive sub-layer 111 and the fourth adhesive sub-layer 113 is selected from a pressure-sensitive adhesive, a water-based adhesive, or a UV-curing adhesive. The pressure-sensitive adhesive, the water-based adhesive, and the UV-curing adhesive are commercially available adhesives. When the material of the adhesive sub-layer between the first adhesive sub-layer 110 and the third adhesive sub-layer 112 is selected from the pressure-sensitive adhesive, it is conducive to the regular arrangement of the adjusting particles 104 in the adhesive sub-layer between the first adhesive sub-layer 110 and the third adhesive sub-layer 112, further enhancing the improvement effect of the adjusting particles 104 on the color viewing angle, the contrast, and other optical properties of the polarizer 100. Moreover, when the material of the adhesive sub-layer between the second adhesive sub-layer 111 and the fourth adhesive sub-layer 113 is selected from the pressure-sensitive adhesive, it is conducive to the regular arrangement of the adjusting particles 104 in the adhesive sub-layer between the second adhesive sub-layer 111 and the fourth adhesive sub-layer 113, further enhancing the improvement effect of the adjusting particles 104 on the color viewing angle, the contrast, and other optical properties of the polarizer 100.

In some embodiments, when the adjusting particles 104 are dispersed in the first adhesive sub-layer 110 and the third adhesive sub-layer 112, or when the adjusting particles 104 are dispersed in the first adhesive sub-layer 110, the third adhesive sub-layer 112, and the adhesive sub-layer between the first adhesive sub-layer 110 and the third adhesive sub-layer 112, the adhesive performance of the first adhesive layer 107 can be improved by setting the fifth adhesive sub-layer 114. A thickness of the fifth adhesive sub-layer 114 is less than or equal to 10 microns, for example, 1 micron, 2 microns, or 3 microns. 4 microns, 5 microns, 6 microns, 7 microns, 8 microns, 9 microns, or the like.

In some embodiments, when the adjusting particles 104 are dispersed in the second adhesive sub-layer 111 and the fourth adhesive sub-layer 113, or when the adjusting particles 104 are dispersed in the second adhesive sub-layer 111, the fourth adhesive sub-layer 113, and the adhesive sub-layer between the second adhesive sub-layer 111 and the fourth adhesive sub-layer 113, the adhesive performance of the second adhesive layer 109 can be improved by setting the sixth adhesive sub-layer 115. A thickness of the sixth adhesive sub-layer 115 is less than or equal to 10 microns, for example, 1 micron, 2 microns, 3 microns, 4 microns, 5 microns, 6 microns, 7 microns, 8 microns, 9 microns, or the like.

When the adjusting particles 104 are dispersed in the adhesive layer 103, the interaction between molecules of the materials of the adhesive layer 103 is destroyed due to the addition of the adjusting particles 104, and the adhesive performance of the adhesive layer 103 is reduced as well. Therefore, in some embodiments, the first protective layer 102 includes a first hydrophilic sub-layer disposed close to the polarizing layer 101, which is conducive to enhancing the peeling force between the adhesive layer 103 in contact with the first protective layer 102 and the first protective layer 102, and increasing the peeling difficulty of the adhesive layer 103 and the first protective layer 102. Specifically, when the first adhesive layer 107 is disposed between the polarizing layer 101 and the first protective layer 102, and the adjusting particles 104 are dispersed in the first adhesive layer 107, a peeling force between the first adhesive layer 107 and the first hydrophilic sub-layer is greater than a peeling force between the first adhesive layer 107 and the polarizing layer 101. Alternatively, when the second adhesive layer 109 is disposed between the first protective layer 102 and the second protective layer 108, and the adjusting particles 104 are dispersed in the second adhesive layer 109, a peeling force between the second adhesive layer 109 and the first hydrophilic sub-layer is greater than a peeling force between the second adhesive layer 109 and the second protective layer 108. Because the peeling force between the first adhesive layer 107 and the first protective layer 102 is different from the peeling force between the first adhesive layer 107 and the polarizing layer 101, or the peeling force between the second adhesive layer 109 and the first protective layer 102 is different from the peeling force between the second adhesive layer 109 and the second protective layer 108, when there is a quality problem with the first protective layer 102 or other film layers disposed at a side of the first protective layer 102 away from the polarizing layer 101, the first protective layer 102 or other film layers disposed at a side of the first protective layer 102 away from the polarizing layer 101 can be peeled or replaced, thereby improving the recycling rate of the polarizer 100 and reducing manufacturing cost.

In some embodiments, when the adjusting particles 104 are dispersed in the second adhesive layer 109, the peeling force between the second adhesive layer 109 and the second protective layer 108 is greater than or equal to 100 gN/mm and less than or equal to 600 gN/mm.

Table 1 illustrates test results of the peeling force between the second adhesive layer 109 and the second protective layer 108, in which the adjusting particles 104 are dispersed in the second adhesive layer 109.

TABLE 1

| | | | Average | Maximum | Interval |
|---|---|---|---|---|---|
| | Width/ | Length/ | peeling | peeling | peeling |
| | mm | mm | force/gN/mm | force/gN/mm | force/gN/mm |
| Sample 1 | 25.00 | 150.00 | 301.03 | 378.22 | 299.69 |
| Sample 2 | 25.00 | 150.00 | 319.29 | 459.35 | 319.48 |
| Sample 3 | 25.00 | 150.00 | 309.41 | 485.53 | 337.20 |
| Sample 4 | 25.00 | 150.00 | 297.69 | 417.63 | 302.80 |
| Sample 5 | 25.00 | 150.00 | 356.67 | 540.75 | 357.59 |
| Average | 25.00 | 150.00 | 316.82 | 456.30 | 323.35 |
| value | | | | | |

The data in Table 1 were obtained by attaching the polarizer 100 to a steel plate at the temperature of 25° C. and using the adhesive peel strength testing machine (model: OMT8501) from Master Industrial System (China) Co., Ltd. Peel angles of the samples were 180°, widths of the samples were 25 mm, lengths of the samples were 150 mm, and peeling speeds of the samples were 300 mm/min.

According to the results in Table 1, the peeling force between the second adhesive layer 109 and the second protective layer 108 is effectively reduced to be less than or equal to 600 gN/mm by adding the adjusting particles 104. When there is a quality problem with the first protective layer 102 or other film layers disposed at a side of the first protective layer 102 away from the polarizing layer 101, the difference in peeling forces facilitates the separation and replacement of the first protective layer 102 and other film layers disposed at a side of the first protective layer 102 away from the polarizing layer 101.

In some embodiments, the hydrophilicity of a surface of the first hydrophilic sub-layer close to the polarizing layer 101 is stronger than the hydrophilicity of a surface of the second protective layer 108 close to the first protective layer 102. Alternatively, the hydrophilicity of the surface of the first hydrophilic sub-layer close to the polarizing layer 101 is stronger than the hydrophilicity of a surface of the first polarizing layer 101 close to the first protective layer 102.

In some embodiments, a water droplet contact angle at a surface of the first hydrophilic sub-layer close to the polarizing layer 101 is less than 90°, for example, 10°, 20°, 30°, 40°, 50°, 60°, 70°, 80°, or the like.

In some embodiments, the second protective layer 108 includes a second hydrophilic sub-layer close to the polarizing layer 101, and the adjusting particles 104 are dispersed in the first adhesive layer 107. A peeling force between the first adhesive layer 107 and the second hydrophilic sub-layer is greater than a peeling force between the first adhesive layer 107 and the second protective layer 108, which is conducive to the separation and replacement of the second protective layer 108 when the second protective layer 108 is damaged, thereby improving the recycling rate of the polarizer 100 and reducing the manufacturing cost.

In some embodiments, the adjusting particles 104 include the first type of adjusting particles 105, the second type of adjusting particles 106, or both of them. When the adjusting particles 104 include the first type of adjusting particles 105 and the second type of adjusting particles 106, the first type of adjusting particles 105 and the second type of adjusting particles 106 are at least partially mixed and dispersed in the first adhesive layer 107, or the first type of adjusting particles 105 and the second type of adjusting particles 106 are dispersed in different layers of the first adhesive layer 107. And/or, when the adjusting particles 104 include the first type of adjusting particles 105 and the second type of adjusting particles 106, the first type of adjusting particles 105 and the second type of adjusting particles 106 are at least partially mixed and dispersed in the second adhesive layer 109, or the first type of adjusting particles 105 and the second type of adjusting particles 106 are dispersed in different layers of the second adhesive layer 109. In some embodiments, the first type of adjusting particles 105 and the second type of adjusting particles 106 are at least partially mixed and dispersed in the first adhesive layer 107. For example, the first type of adjusting particles 105 and the second type of adjusting particles 106 are dispersed at least in the first adhesive sub-layer 110. In some embodiments, the first type of adjusting particles 105 and the second type of adjusting particles 106 are dispersed in different layers of the first adhesive layer 107, for example, the first type of adjusting particles 105 are dispersed in the first adhesive sub-layer 110, and the second type of adjusting particles 106 are dispersed in the third adhesive sub-layer 112; alternatively, the first type of adjusting particles 105 are dispersed in the third adhesive sub-layer 112, and the second type of adjusting particles 106 are dispersed in the first adhesive sub-layer 110; alternatively, the first type of adjusting particles 105 are dispersed in the first adhesive sub-layer 110 and the third adhesive sub-layer 112, and the second type of adjusting particles 106 are dispersed in the adhesive sub-layer between the first adhesive sub-layer 110 and the third adhesive sub-layer 112; alternatively, the first type of adjusting particles 105 are dispersed in the first adhesive sub-layer 110 and the adhesive sub-layer between the first adhesive sub-layer 110 and the third adhesive sub-layer 112, and the second type of adjusting particles 106 are dispersed in the third adhesive sub-layer 112; alternatively, the first type of adjusting particles 105 are dispersed in the adhesive sub-layer between the first adhesive sub-layer 110 and the third adhesive sub-layer 112, and dispersed in the third adhesive sub-layer 112, and the second type of adjusting particles 106 are dispersed in the first adhesive sub-layer 110; alternatively, the second type of adjusting particles 106 are dispersed in the first adhesive sub-layer 110 and the third adhesive sub-layer 112, and the first type of adjusting particles 105 are dispersed in the adhesive sub-layer between the first adhesive sub-layer 110 and the third adhesive sub-layer 112; alternatively, the second type of adjusting particles 106 are dispersed in the first adhesive sub-layer 110 and the adhesive sub-layer between the first adhesive sub-layer 110 and the third adhesive sub-layer 112, and the first type of adjusting particles 105 are dispersed in the third adhesive sub-layer 112; and alternatively, the second type of adjusting particles 106 are dispersed in the adhesive sub-layer between the first adhesive sub-layer 110 and the third adhesive sub-layer 112, and dispersed in the third adhesive sub-layer 112, and the first type of adjusting particles 105 are dispersed in the first adhesive sub-layer 110.

In some embodiments, an acute angle is formed between the major axis of one of the first type of adjusting particles 105 and the first plane, and the acute angle is related to the thickness of the adhesive sub-layer in which the first type of adjusting particles 105 are dispersed, and related to a length of the major axis of one of the first type of adjusting particles 105. Specifically, the acute angle is less than or equal to arcsin (d/L), in which d represents the thickness of the adhesive sub-layer in which the first type of adjusting particles 105 are dispersed, for example, the thickness of the first adhesive sub-layer 110, and L represents the length of the major axis of one of the first type of adjusting particles 105.

In some embodiments, the acute angle is greater than 0° and less than or equal to 40°, for example, 1°, 2°, 5°, 8°, 10°, 12°, 15°, 18°, 20°, 25°, 28°, 30°, 35°, 38°, or the like, to increase the scattering amount of the first type of adjusting particles 105 to light irradiating from a direction parallel to the first plane, thereby enhancing the improvement effect of the first type of adjusting particles 105 on the color viewing angle and the contrast of the polarizer 100. In some embodiments, the acute angle is greater than 0° and less than or equal to 20°, further enhancing the improvement effect of the first type of adjusting particles 105 on the color viewing angle and the contrast of the polarizer 100.

In some embodiments, each of the adjusting particles 104 has a major axis and a diameter, and a length of a major axis of each of the adjusting particles 104 is equal to a distance between two end points of the major axis of each of the adjusting particles 104. Each of the adjusting particles 104 has a plurality of cross-sectional surfaces in an extension direction perpendicular to the major axis of each of the adjusting particles 104. Each of the cross-sectional surfaces has an inscribed circle. The diameter of each of the adjusting particles 104 is equal to the diameter of the inscribed circle with a largest diameter among the plurality of cross-sectional surfaces of the each of the adjusting particles 104. The farthest two points in a cross-sectional surface of each of the adjusting particles 104 are located in the inscribed circle of the cross-sectional surface, and a distance between the farthest two points in the cross-sectional surface is the diameter of the inscribed circle.

In some embodiments, the adjusting particles 104 include the first type of adjusting particles 105 to improve the color viewing angle and the contrast of the polarizer 100. Each of the first type of adjusting particles 105 has a plurality of first cross-sectional surfaces, and each of the first cross-sectional surfaces has a first inscribed circle. The ratio of the length of the major axis of each of the first type of adjusting particles 105 to the diameter of the first inscribed circle with the largest diameter among the plurality of first inscribed circles is greater than or equal to 5 and less than 50, for example, 10, 12, 15, 16, 18, 20, 30, 32, 34. 35, 36, 38, 40, 42, 45, 46, 48, or the like. Each of the first cross-sectional surfaces is perpendicular to an extension direction of the major axis of each of the first type of adjusting particles 105. The diameter of the first inscribed circle of one of the first cross-sectional surfaces of each of the first type of adjusting particles 105 is equal to the diameter of a circle with a largest diameter among a plurality of circles of the first cross-sectional surfaces and tangent to the edge of one of the first cross-sectional surfaces. The addition of the first type of adjusting particles 105 with a larger length-diameter ratio (the ratio of the length of the major axis to the diameter of the first inscribed circle with the largest diameter) in the adjusting particles 104 makes it easier to change the propagation direction of light, which is conducive to enhancing the improvement effect of the adjusting particles 104 on the color viewing angle and the contrast.

In some embodiments, the first type of adjusting particles 105 are selected from at least one of first sub-type of adjusting particles, second sub-type of adjusting particles, third sub-type of adjusting particles, fourth sub-type of adjusting particles, and fifth sub-type of adjusting particles with different shapes.

A variation value of the diameters of the first inscribed circles of the first cross-sectional surfaces of one of the first sub-type of adjusting particles along an extension direction of a major axis of one of the first sub-type of adjusting particles is less than or equal to 0.3 microns, for example, 0.28 microns, 0.25 microns, 0.22 microns, 0.2 microns, 0.18 microns, 0.15 microns, 0.12 microns, 0.1 microns, 0.08 microns, 0.05 microns, 0.02 microns, or the like. In some embodiments, along the extension direction of the major axis of one of the first sub-type of adjusting particles, the diameter of the first inscribed circle of one of the first cross-sectional surfaces of a middle part of one of the first sub-type of adjusting particles is equal to the diameter of the first inscribed circle of one of the first cross-sectional surfaces of a first end of one of the first sub-type of adjusting particles, and equal to the diameter of the first inscribed circle of one of the first cross-sectional surfaces of a second end of one of the first sub-type of adjusting particles.

In some embodiments, the first cross-sectional surfaces of one of the first sub-type of adjusting particles may be circular, elliptical, triangular, quadrilateral, or other regular or irregular shapes.

In some embodiments, the first sub-type of adjusting particles are rod-shaped particles. When the first sub-type of adjusting particles are the rod-shaped particles, the first cross-sectional surfaces of one of the first sub-type of adjusting particles are circular or elliptical. When the first cross-sectional surfaces of one of the first sub-type of adjusting particles are circular, the first inscribed circles of the first cross-sectional surfaces of one of the first sub-type of adjusting particles coincide with the first cross-sectional surfaces. When the first cross-sectional surfaces of one of the first sub-type of adjusting particles are elliptical, the diameter of the first inscribed circle of each of the first cross-sectional surfaces of one of the first sub-type of adjusting particles is equal to a length of a minor axis of an ellipse (the shape of each of the first cross-sectional surfaces of one of the first sub-type of adjusting particles). A ratio of the length of the major axis of the ellipse to a length of a minor axis of the ellipse is greater than 1 and less than or equal to 3, for example, 1.2, 1.5, 1.8, 2, 2.2, 2.5, 2.8, or the like.

A variation value of the diameters of the first inscribed circles of the first cross-sectional surfaces of a middle part of one of the second sub-type of adjusting particles along an extension direction of a major axis of one of the second sub-type of adjusting particles is less than or equal to 1 micron, for example, 0.95 microns, 0.8 microns, 0.78 microns, 0.75 microns, 0.72 microns, 0.7 microns, 0.68 microns, 0.65 microns, 0.62 microns, 0.6 microns, 0.58 microns, 0.52 microns, 0.5 microns, 0.48 microns, 0.45 microns, 0.42 microns, 0.4 microns, 0.38 microns, 0.35 microns, 0.32 microns, 0.3 microns, 0.28 microns, 0.25 microns, 0.22 microns, 0.2 microns, 0.18 microns, 0.15 microns, 0.12 microns, 0.1 microns, 0.08 microns, 0.05 microns, 0.02 microns, or the like. Along a direction away from the middle part of one of the second sub-type of adjusting particles, the diameters of the first inscribed circles of the first cross-sectional surfaces of a first end of one of the second sub-type of adjusting particles gradually decrease, and a change value of the diameters of the first inscribed circles of the first cross-sectional surfaces of a second end of one of the second sub-type of adjusting particles is less than or equal to 1 micron, for example, 0.95 microns, 0.8 microns, 0.78 microns, 0.75 microns, 0.72 microns, 0.7 microns, 0.68 microns, 0.65 microns, 0.62 microns, 0.6 microns, 0.58 microns, 0.55 microns, 0.52 microns, 0.5 microns, 0.48 microns, 0.45 microns, 0.42 microns, 0.42 microns, 0.4 microns, 0.38 microns, 0.35 microns, 0.32 microns, 0.3 microns, 0.28 microns, 0.25 microns, 0.22 microns, 0.2 microns, 0.18 microns, 0.15 microns, 0.12 microns, 0.1 microns, 0.08 microns, 0.05 microns 0.02 microns, or the like. In some embodiments, the diameters of the first inscribed circles of the first sectional surfaces of the first end of one of the second sub-type of adjusting particles gradually decrease along the direction away from the middle part of one of the second sub-type of adjusting particles, and the diameters of the first inscribed circles of the first sectional surfaces of the second end of one of the second sub-type of adjusting particles are equal to the diameters of the first inscribed circles of the first sectional surfaces of the middle part of one of the second sub-type of adjusting particles.

It can be understood that the diameters of the first inscribed circles of the first cross-sectional surfaces of the first end of one of the second sub-type of adjusting particles gradually decrease along the direction away from the middle part of one of the second sub-type of adjusting particles, indicating that the diameters of the first inscribed circles of the first cross-sectional surfaces of the first end of one of the second sub-type of adjusting particles show a decreasing trend along the direction away from the middle part of one of the second sub-type of adjusting particles, including but not limited to the diameters of the first inscribed circles of the first cross-sectional surfaces of the first end of one of the second sub-type of adjusting particles decreasing sequentially along the direction away from the middle part of one of the second sub-type of adjusting particles.

In some embodiments, the first cross-sectional surfaces of one of the second sub-type of adjusting particles may be circular, elliptical, triangular, quadrilateral, or other regular or irregular shapes.

In some embodiments, the second sub-type of adjusting particles are needle-shaped particles with one end having a smaller diameter than another end.

In some embodiments, when the second sub-type of adjusting particles are needle-shaped particles with one end having a smaller diameter than another end, the first cross-sectional surfaces of one of the second sub-type of adjusting particles are circular or elliptical. When the first cross-sectional surfaces of the second end of one of the second sub-type of adjusting particles or the first cross-sectional surfaces of the middle part of one of the second sub-type of adjusting particles are elliptical, a ratio of a major axis of an ellipse (the shape of each of the first cross-sectional surfaces of the second end or the middle part of one of the second sub-type of adjusting particles) to a minor axis of the ellipse is greater than 1 and less than or equal to 3, for example, 1.2, 1.5, 1.8, 2, 2.2, 2.5, 2.8, or the like. Shapes of the first cross-sectional surfaces of the first end of one of the second sub-type of adjusting particles are the same as shapes of the first cross-sectional surfaces of the middle part of one of the second sub-type of adjusting particles, and areas of the first cross-sectional surfaces of one of the second sub-type of adjusting particles gradually decrease along the direction away from the middle part of one of the second sub-type of adjusting particles.

A variation value of the diameters of the first inscribed circles of the first cross-sectional surfaces of a middle part of one of the third sub-type of adjusting particles along an extension direction of a major axis of one of the third sub-type of adjusting particles is less than or equal to 1 micron, for example, 0.95 microns, 0.8 microns, 0.78 microns, 0.75 microns, 0.72 microns, 0.7 microns, 0.68 microns, 0.65 microns, 0.62 microns, 0.6 microns, 0.58 microns, 0.52 microns, 0.5 microns, 0.48 microns, 0.45 microns, 0.42 microns, 0.4 microns, 0.38 microns, 0.35 microns, 0.32 microns, 0.3 microns, 0.28 microns, 0.25 microns, 0.22 microns, 0.2 microns, 0.18 microns, 0.15 microns, 0.12 microns, 0.1 microns, 0.08 microns, 0.05 microns, 0.02 microns, or the like. Along a direction away from the middle part of one of the third sub-type of adjusting particles, the diameters of the first inscribed circles of the first cross-sectional surfaces of a first end of one of the third sub-type of adjusting particles gradually decrease, and the diameters of the first inscribed circles of the first cross-sectional surfaces of a second end of one of the third sub-type of adjusting particles gradually decrease as well. In some embodiments, along the extension direction of the major axis of one of the third sub-type of adjusting particles, the diameters of the first inscribed circles of the first cross-sectional surfaces of the middle part of one of the third sub-type of adjusting particles are substantially equal, and the diameters of the first inscribed circles of the first cross-sectional surfaces of the first end and the second end of one of the third sub-type of adjusting particles gradually change, respectively.

It can be understood that, along the direction away from the middle part of one of the third sub-type of adjusting particles, the diameters of the first inscribed circles of the first cross-sectional surfaces of the first end of one of the third sub-type of adjusting particles gradually decrease, indicating that the diameters of the first inscribed circles of the first cross-sectional surfaces of the first end of one of the third sub-type of adjusting particles show a decreasing trend, and including, but not limited to, the diameters of the first inscribed circles of the first cross-sectional surfaces of the first end of one of the third sub-type of adjusting particles decreasing sequentially.

It can be understood that, along the direction away from the middle part of one of the third sub-type of adjusting particles, the diameters of the first inscribed circles of the first cross-sectional surfaces of the second end of one of the third sub-type of adjusting particles gradually decrease, indicating that the diameters of the first inscribed circles of the first cross-sectional surfaces of the second end of one of the third sub-type of adjusting particles show a decreasing trend, including, but not limited to, the diameters of the first inscribed circles of the first cross-sectional surfaces of the second end of one of the third sub-type of adjusting particles decreasing sequentially.

In some embodiments, the first cross-sectional surfaces of one of the third sub-type of adjusting particles may be circular, elliptical, triangular, quadrilateral, or other regular or irregular shapes.

In some embodiments, the third sub-type of adjusting particles are needle-shaped particles with two opposite ends having a smaller diameter than the middle.

In some embodiments, when the third sub-type of adjusting particles are needle-shaped particles with two opposite ends having a smaller diameter than the middle, the first cross-sectional surfaces of one of the third sub-type of adjusting particles are circular or elliptical. When the first cross-sectional surfaces of the middle part of one of the third sub-type of adjusting particles are elliptical, a ratio of a major axis of an ellipse (the shape of each of the first cross-sectional surfaces of the middle part of one of the third sub-type of adjusting particles) to a minor axis of the ellipse is greater than 1 and less than or equal to 3, for example, 1.2, 1.5, 1.8, 2, 2.2, 2.5, 2.8, or the like. Shapes of the first cross-sectional surfaces of the first end, the second end, and the middle part of one of the third sub-type of adjusting particles are the same, and areas of the first cross-sectional surfaces of one of the third sub-type of adjusting particles gradually decrease along the direction away from the middle part of one of the third sub-type of adjusting particles.

A first end of one of the fourth sub-type of adjusting particles is connected to a second end of one of the fourth sub-type of adjusting particles. The diameters of the first inscribed circles of the first cross-sectional surfaces of one of the fourth sub-type of adjusting particles gradually decrease along a direction from the first end of one of the fourth sub-type of adjusting particles to the second end of one of the fourth sub-type of adjusting particles.

It can be understood that, along the direction from the first end of one of the fourth sub-type of adjusting particles to the second end of one of the fourth sub-type of adjusting particles, the diameters of the first inscribed circles of the first cross-sectional surfaces of one of the fourth sub-type of adjusting particles gradually decrease, indicating that the diameters of the first inscribed circles of the first cross-sectional surfaces of one of the fourth sub-type of adjusting particles show a decreasing trend, including but not limited to the diameters of the first inscribed circles of the first cross-sectional surfaces of one of the fourth sub-type of adjusting particles decreasing sequentially.

In some embodiments, the first cross-sectional surfaces of one of the fourth sub-type of adjusting particles may be circular, elliptical, triangular, quadrilateral, or other regular or irregular shapes.

In some embodiments, the fourth subcategory of adjusting particles are long cone-shaped particles.

In some embodiments, when the fourth sub-type of adjusting particles are long cone-shaped particles, the first cross-sectional surfaces of one of the fourth sub-type of adjusting particles are circular or elliptical. Along the direction from the first end of one of the fourth sub-type of adjusting particles to the second end of one of the fourth sub-type of adjusting particles, shapes of the first cross-sectional surfaces of one of the fourth sub-type of adjusting particles are the same, and areas of the first cross-sectional surfaces of one of the fourth sub-type of adjusting particles gradually decrease. When the first cross-sectional surfaces of one of the fourth sub-type of adjusting particles are elliptical, a ratio of a major axis of an ellipse (the shape of each of the first cross-sectional surfaces of one of the fourth sub-type of adjusting particles) to a minor axis of the ellipse is greater than 1 and less than or equal to 3, for example, 1.2, 1.5, 1.8, 2, 2.2, 2.5, 2.8, or the like.

A first end of one of the fifth sub-type of adjusting particles is connected to a second end of one of the fifth sub-type of adjusting particles. The diameters of the first inscribed circles of the first cross-sectional surfaces of the first end of one of the fifth sub-type of adjusting particles gradually decrease along a direction away from the second end of one of the fifth sub-type of adjusting particles. The diameters of the first inscribed circles of the first cross-sectional surfaces of the second end of one of the fifth sub-type of adjusting particles gradually decrease along a direction away from the first end of one of the fifth sub-type of adjusting particles.

It can be understood that, along the direction away from the second end of one of the fifth sub-type of adjusting particles, the diameters of the first inscribed circles of the first cross-sectional surfaces of the first end of one of the fifth sub-type of adjusting particles gradually decrease, indicating that the diameters of the first inscribed circles of the first cross-sectional surfaces of the first end of one of the fifth sub-type of adjusting particles show a decreasing trend, including but not limited to the diameters of the first cross-sectional surfaces of the first end of one of the fifth sub-type of adjusting particles decreasing sequentially.

It can be understood that, along the direction away from the first end of one of the fifth sub-type of adjusting particles, the diameters of the first inscribed circles of the first cross-sectional surfaces of the second end of one of the fifth sub-type of adjusting particles gradually decrease, indicating that the diameters of the first inscribed circles of the first cross-sectional surfaces of the second end of one of the fifth sub-type of adjusting particles show a decreasing trend, including but not limited to the diameters of the first cross-sectional surfaces of the second end of one of the fifth sub-type of adjusting particles decreasing sequentially.

In some embodiments, the first cross-sectional surfaces of one of the fifth sub-type of adjusting particles may be circular, elliptical, triangular, quadrilateral, or other regular or irregular shapes.

In some embodiments, the fifth sub-type of adjusting particles are biconical particles, ellipsoidal particles, or both of them.

In some embodiments, when the fifth sub-type of adjusting particles are biconical particles, ellipsoidal particles, or both of them, the first cross-sectional surfaces of one of the fifth sub-type of adjusting particles are circular or elliptical. Along the direction away from the second end of one of the fifth sub-type of adjusting particles, shapes of the first cross-sectional surfaces of the first end of one of the fifth sub-type of adjusting particles are the same, and areas of the first cross-sectional surfaces of the first end of one of the fifth sub-type of adjusting particles gradually decrease. Along the direction away from the first end of one of the fifth sub-type of adjusting particles, shapes of the first cross-sectional surfaces of the second end of one of the fifth sub-type of adjusting particles are the same, and areas of the first cross-sectional surfaces of the second end of one of the fifth sub-type of adjusting particles gradually decrease. When the first cross-sectional surfaces of one of the fifth sub-type of adjusting particles are elliptical, a ratio of a major axis of an ellipse (the shape of each of the first cross-sectional surfaces of one of the fifth sub-type of adjusting particles) to a minor axis of the ellipse is greater than 1 and less than or equal to 3, for example, 1.2, 1.5, 1.8, 2, 2.2, 2.5, 2.8, or the like.

For the fifth sub-type of adjusting particles, the difference between the biconical particles and the ellipsoidal particles is mainly in the shape of the cross-sectional surface. When the fifth sub-type of adjusting particles are the biconical particles, cross-sectional surfaces of each of the fifth sub-type of adjusting particles in a direction parallel to a major axis of each of the fifth sub-type of adjusting particles are triangle, quadrilateral, or other polygons. When the fifth sub-type of adjusting particles are the ellipsoidal particles, the cross-sectional surfaces of the fifth sub-type of adjusting particles in the direction parallel to the major axis of each of the fifth sub-type of adjusting particles are elliptical.

In some embodiments, the length of the major axis of one of the first type of adjusting particles 105 is less than or equal to 30 microns, for example, 5 microns, 8 microns, 10 microns, 12 microns, 15 microns, 16 microns, 18 microns, 20 microns, 22 microns, 23 microns, 24 microns, 25 microns, 26 microns, 28 microns, or the like, to facilitate the dispersion of the first type of adjusting particles 105 in the first adhesive layer 107, thereby effectively improving the color viewing angle of the polarizer 100.

In some embodiments, the diameter of the first inscribed circle with the largest diameter among the plurality of first inscribed circles of one of the first type of adjusting particles 105 is less than or equal to 5 microns, for example, 0.5 microns, 1 micron, 1.5 microns, 2 microns, 2.5 microns, 3 microns, 3.5 microns, 4 microns, 4.5 microns, or the like. Furthermore, the diameter of the first inscribed circle with the largest diameter among the plurality of first inscribed circles of one of the first type of adjusting particles 105 is greater than or equal to 1 micron.

In some embodiments, the adjusting particles 104 include the second type of adjusting particles 106.

In some embodiments, each of the second type of adjusting particles 106 has a plurality of second cross-sectional surfaces, and each of the second cross-sectional surfaces has a second inscribed circle. The ratio of the length of the major axis of each of the second type of adjusting particles 106 to the diameter of the second inscribed circle with the largest diameter among the plurality of second inscribed circles is greater than or equal to 1 and less than 5, for example, 1.1, 1.2, 1.3, 1.4, 1.5, 1.6, 1.7, 1.8, 1.9, 2, 2.2, 2.5 2.8, 3, 3.5, 4, 4.5, or the like. Each of the second cross-sectional surfaces is perpendicular to an extension direction of the major axis of each of the second type of adjusting particles 106. The diameter of the second inscribed circle of one of the second cross-sectional surfaces of each of the second type of adjusting particles 106 is equal to the diameter of a circle with a largest diameter among a plurality of circles of the second cross-sectional surfaces and tangent to the edge of one of the second cross-sectional surfaces. By adding the adjusting particles 104 including the second type of adjusting particles 106 with a smaller length-diameter ratio (the ratio of the length of the major axis to the diameter of the second inscribed circle with the largest diameter), it is conducive to improving the contrast and other optical properties of the polarizer 100.

In some embodiments, the second type of adjusting particles 106 are selected from at least one of sixth sub-type of adjusting particles, seventh sub-type of adjusting particles, eighth sub-type of adjusting particles, ninth sub-type of adjusting particles, and tenth sub-type of adjusting particles with different shapes.

A variation value of the diameters of the second inscribed circles of the second cross-sectional surfaces of one of the sixth sub-type of adjusting particles along an extension direction of a major axis of one of the sixth sub-type of adjusting particles is less than or equal to 0.3 microns, for example, 0.28 microns, 0.25 microns, 0.22 microns, 0.2 microns, 0.18 microns, 0.15 microns, 0.12 microns, 0.1 microns, 0.08 microns, 0.05 microns, 0.02 microns, or the like. In some embodiments, along the extension direction of the major axis of one of the sixth sub-type of adjusting particles, the diameter of the second inscribed circle of one of the second cross-sectional surfaces of a middle part of one of the sixth sub-type of adjusting particles is equal to the diameter of the second inscribed circle of one of the second cross-sectional surfaces of a first end of one of the sixth sub-type of adjusting particles, and equal to the diameter of the second inscribed circle of one of the second cross-sectional surfaces of a second end of one of the sixth sub-type of adjusting particles.

In some embodiments, the second cross-sectional surfaces of one of the sixth sub-type of adjusting particles may be circular, elliptical, triangular, quadrilateral, or other regular or irregular shapes.

In some embodiments, the sixth sub-type of adjusting particles are cubic or rectangular particles, and shapes of the second cross-sectional surfaces of one of the sixth sub-type of adjusting particles are square or rectangle. The diameter of the second inscribed circle of each of the second cross-sectional surfaces of one of the sixth sub-type of adjusting particles is equal to a length of a side of the square or a length of a short side of the rectangle (the shape of each of the second cross-sectional surfaces of one of the sixth sub-type of adjusting particles).

A ratio of a length of the major axis of one of the sixth sub-type of adjusting particles to the diameter of the second inscribed circle with the largest diameter among the plurality of second inscribed circles of the second cross-sectional surfaces of one of the sixth sub-type of adjusting particles is preferably close to 1, for example, 1.1, 1.2, 1.3, 1.4, 1.5, 1.6, 1.7, 1.8, 1.9, 2, 2.2, 2.5, 3, or the like.

A first end of one of the seventh sub-type of adjusting particles is connected to a second end of one of the seventh sub-type of adjusting particles. The diameters of the second inscribed circles of the second cross-sectional surfaces of the first end of one of the seventh sub-type of adjusting particles gradually decrease along a direction away from the second end of one of the seventh sub-type of adjusting particles. The diameters of the second inscribed circles of the second cross-sectional surfaces of the second end of one of the seventh sub-type of adjusting particles gradually decrease along a direction away from the first end of one of the seventh sub-type of adjusting particles.

It can be understood that, along the direction away from the second end of one of the seventh sub-type of adjusting particles, the diameters of the second inscribed circles of the second cross-sectional surfaces of the first end of one of the seventh sub-type of adjusting particles gradually decrease, indicating that the diameters of the second inscribed circles of the second cross-sectional surfaces of the first end of one of the seventh sub-type of adjusting particles show a decreasing trend, including but not limited to the diameters of the second inscribed circles of the second cross-sectional surfaces of the first end of one of the seventh sub-type of adjusting particles decreasing sequentially.

It can be understood that, along the direction away from the first end of one of the seventh sub-type of adjusting particles, the diameters of the second inscribed circles of the second cross-sectional surfaces of the second end of one of the seventh sub-type of adjusting particles gradually decrease, indicating that the diameters of the second inscribed circles of the second cross-sectional surfaces of the second end of one of the seventh sub-type of adjusting particles show a decreasing trend, including but not limited to the diameters of the second inscribed circles of the second cross-sectional surfaces of the second end of one of the seventh sub-type of adjusting particles decreasing sequentially.

In some embodiments, the second cross-sectional surfaces of one of the seventh sub-type of adjusting particles may be circular, elliptical, triangular, quadrilateral, or other regular or irregular shapes.

In some embodiments, the seventh sub-type of adjusting particles are spherical particles or ellipsoidal particles, and the second cross-sectional surfaces of one of the seventh sub-type of adjusting particles are circular or elliptical. When the second cross-sectional surfaces of one of the seventh sub-type of adjusting particles are elliptical, a ratio of a major axis of an ellipse (the shape of each of the second cross-sectional surfaces of one of the seventh sub-type of adjusting particles) to a minor axis of the ellipse is greater than 1 and less than or equal to 3, for example, 1.2, 1.5, 1.8, 2, 2.2, 2.5, 2.8, or the like. When the seventh sub-type of adjusting particles are spherical particles, each of the second cross-sectional surfaces of one of the seventh sub-type of adjusting particles is circular and the second inscribed circle of each of the second cross-sectional surfaces coincides with the second cross-sectional surface, and a ratio of a minor axis of one of the seventh sub-type of adjusting particles to the diameter of the second inscribed circle with the largest diameter among the plurality of second inscribed circles of the second cross-sectional surfaces of one of the seventh sub-type of adjusting particles is 1.

A ratio of a length of a major axis of one of the seventh sub-type of adjusting particles to the diameter of the second inscribed circle with the largest diameter among the plurality of second inscribed circles of one of the seventh sub-type of adjusting particles is preferably close to 1. When the seventh sub-type of adjusting particles are ellipsoidal particles, the seventh sub-type of adjusting particles are preferably similar to spherical particles, that is, the length of the major axis of one of the seventh sub-type of adjusting particles is preferably close to be equal to the diameter of one of the seventh sub-type of adjusting particles. Preferably, the ratio of the length of the major axis of one of the seventh sub-type of adjusting particles to the diameter of the second inscribed circle with the largest diameter among the plurality of second inscribed circles of one of the seventh sub-type of adjusting particles is greater than or equal to 1 and less than or equal to 3. More preferably, the ratio of the length of the major axis of one of the seventh sub-type of adjusting particles to the diameter of the second inscribed circle with the largest diameter among the plurality of second inscribed circles of one of the seventh sub-type of adjusting particles is greater than or equal to 1 and less than or equal to 1.5.

A variation value of the diameters of the second inscribed circles of the second cross-sectional surfaces of a middle part of one of the eighth sub-type of adjusting particles along an extension direction of a major axis of one of the eighth sub-type of adjusting particles is less than or equal to 1 micron, for example, 0.95 microns, 0.8 microns, 0.78 microns, 0.75 microns, 0.72 microns, 0.7 microns, 0.68 microns, 0.65 microns, 0.62 microns, 0.6 microns, 0.58 microns, 0.55 microns, 0.52 microns, 0.5 microns, 0.48 microns, 0.45 microns, 0.42 microns, 0.38 microns, 0.35 microns, 0.32 microns, 0.3 microns, 0.28 micron. 0.25 microns, 0.22 microns, 0.2 microns, 0.18 microns, 0.15 microns, 0.12 microns, 0.1 microns, 0.08 microns, 0.05 microns, 0.02 microns, or the like. Along a direction away from the middle part of one of the eighth sub-type of adjusting particles, the diameters of the second inscribed circles of the second cross-sectional surfaces of a first end of one of the eighth sub-type of adjusting particles gradually decrease, and a variation value of the diameters of the second inscribed circles of the second cross-sectional surfaces of a second end of one of the eighth sub-type of adjusting particles is less than or equal to 1 micron, for example, 0.95 microns, 0.8 microns, 0.78 microns, 0.75 microns, 0.72 microns, 0.7 microns, 0.68 microns, 0.65 microns, 0.62 microns, 0.6 microns, 0.58 microns, 0.55 microns, 0.52 microns, 0.5 microns, 0.48 microns, 0.45 microns, and 0.45 microns. 0.42 microns, 0.4 microns, 0.38 microns, 0.35 microns, 0.32 microns, 0.3 microns, 0.28 microns, 0.25 microns, 0.22 microns, 0.2 microns, 0.18 microns, 0.15 microns, 0.12 microns, 0.1 microns, 0.08 microns, 0.05 microns 0.02 microns, or the like. In some embodiments, the diameters of the second inscribed circles of the second cross-sectional surfaces of the first end of one of the eighth sub-type of adjusting particles gradually decrease along the direction away from the middle part of one of the eighth sub-type of adjusting particles, and the diameters of the second inscribed circles of the second cross-sectional surfaces of the second end of one of the eighth sub-type of adjusting particles are equal to the diameters of the second inscribed circles of the second cross-sectional surfaces of the middle part of one of the eighth sub-type of adjusting particles.

It can be understood that, along the direction away from the middle part of one of the eighth sub-type of adjusting particles, the diameters of the second inscribed circles of the second cross-sectional surfaces of the first end of one of the eighth sub-type of adjusting particles gradually decrease, indicating that the diameters of the second inscribed circles of the second cross-sectional surfaces of the first end of one of the eighth sub-type of adjusting particles show a decreasing trend, including but not limited to the diameters of the second inscribed circles of the second cross-sectional surfaces of the first end of one of the eighth sub-type of adjusting particles decreasing sequentially.

In some embodiments, the second cross-sectional surfaces of one of the eighth sub-type of adjusting particles may be circular, elliptical, triangular, quadrilateral, or other regular or irregular shapes.

In some embodiments, the eighth sub-type of adjusting particles are needle-shaped particles with one end having a smaller diameter than another end.

In some embodiments, when the eighth sub-type of adjusting particles are needle-shaped particles with one end having a smaller diameter than another end, the second cross-sectional surfaces of one of the eighth sub-type of adjusting particles are circular or elliptical. When the second cross-sectional surfaces of the second end of one of the eighth sub-type of adjusting particles or the second cross-sectional surfaces of the middle part of one of the eighth sub-type of adjusting particles are elliptical, a ratio of a major axis of an ellipse (the shape of each of the second cross-sectional surfaces of the second end or the middle part of one of the eighth sub-type of adjusting particles) to a minor axis of the ellipse is greater than 1 and less than or equal to 3, for example, 1.2, 1.5, 1.8, 2, 2.2, 2.5 2.8, or the like. Shapes of the second cross-sectional surfaces of the first end of one of the eighth sub-type of adjusting particles are the same as shapes of the second cross-sectional surfaces of the middle part of one of the eighth sub-type of adjusting particles, and areas of the second cross-sectional surfaces of one of the eighth sub-type of adjusting particles gradually decrease along the direction away from the middle part of one of the eighth sub-type of adjusting particles.

A variation value of the diameters of the second inscribed circles of the second cross-sectional surfaces of a middle part of one of the ninth sub-type of adjusting particles along an extension direction of a major axis of one of the ninth sub-type of adjusting particles is less than or equal to 1 micron, for example, 0.95 microns, 0.8 microns, 0.78 microns, 0.75 microns, 0.72 microns, 0.7 microns, 0.68 microns, 0.65 microns, 0.62 microns, 0.6 microns, 0.58 microns, 0.55 microns, 0.52 microns, 0.5 microns, 0.48 microns, 0.45 microns, 0.4 microns, 0.38 microns, 0.35 microns, 0.32 microns, 0.3 microns, 0.28 micron. 0.25 microns, 0.22 microns, 0.2 microns, 0.18 microns, 0.15 microns, 0.12 microns, 0.1 microns, 0.08 microns, 0.05 microns, 0.02 microns, or the like. Along a direction away from the middle part of one of the ninth sub-type of adjusting particles, the diameters of the second inscribed circles of the second cross-sectional surfaces of a first end of one of the ninth sub-type of adjusting particles gradually decrease, and the diameters of the second inscribed circles of the second cross-sectional surfaces of a second end of one of the ninth sub-type of adjusting particles gradually decrease. In some embodiments, along the extension direction of the major axis of one of the ninth sub-type of adjusting particles, the diameters of the second inscribed circles of the second cross-sectional surfaces of the middle part of one of the ninth sub-type of adjusting particles are the same, and the diameters of the second inscribed circles of the second cross-sectional surfaces of the first end of one of the ninth sub-type of adjusting particles and the diameters of the second inscribed circles of the second cross-sectional surfaces of the second end of one of the ninth sub-type of adjusting particles gradually change, respectively.

It can be understood that, along the direction away from the middle part of one of the ninth sub-type of adjusting particles, the diameters of the second inscribed circles of the second cross-sectional surfaces of the first end of one of the ninth sub-type of adjusting particles gradually decrease, indicating that the diameters of the second inscribed circles of the second cross-sectional surfaces of the first end of one of the ninth sub-type of adjusting particles show a decreasing trend, including but not limited to the diameters of the second inscribed circles of the second cross-sectional surfaces of the first end of one of the ninth sub-type of adjusting particles decreasing sequentially.

It can be understood that, along the direction away from the middle part of one of the ninth sub-type of adjusting particles, the diameters of the second inscribed circles of the second cross-sectional surfaces of the second end of one of the ninth sub-type of adjusting particles gradually decrease, indicating that the diameters of the second inscribed circles of the second cross-sectional surfaces of the second end of one of the ninth sub-type of adjusting particles show a decreasing trend, including but not limited to the diameters of the second inscribed circles of the second cross-sectional surfaces of the second end of one of the ninth sub-type of adjusting particles decreasing sequentially.

In some embodiments, the second cross-sectional surfaces of one of the ninth sub-type of adjusting particles may be circular, elliptical, triangular, quadrilateral, or other regular or irregular shapes.

In some embodiments, the ninth sub-type of adjusting particles may be needle-shaped particles with two opposite ends having a smaller diameter than the middle.

In some embodiments, when the ninth sub-type of adjusting particles are needle-shaped particles with two opposite ends having a smaller diameter than the middle, the second cross-sectional surfaces of one of the ninth sub-type of adjusting particles are circular or elliptical. When the second cross-sectional surfaces of the middle part of one of the ninth sub-type of adjusting particles are elliptical, a ratio of a major axis of an ellipse (the shape of each of the second cross-sectional surfaces of the middle part of one of the ninth sub-type of adjusting particles) to a minor axis of the ellipse is greater than 1 and less than or equal to 3, for example, 1.2, 1.5, 1.8, 2, 2.2, 2.5, 2.8, or the like. Shapes of the second cross-sectional surfaces of the first end, the second end, and the middle part of one of the ninth sub-type of adjusting particles are the same, and areas of the second cross-sectional surfaces of one of the ninth sub-type of adjusting particles gradually decrease along the direction away from the middle part of one of the ninth sub-type of adjusting particles.

A first end of one of the tenth sub-type of adjusting particles is connected to a second end of one of the tenth sub-type of adjusting particles. The diameters of the second inscribed circles of the second cross-sectional surfaces of one of the tenth sub-type of adjusting particles gradually decrease along a direction from the first end of one of the tenth sub-type of adjusting particles to the second end of one of the tenth sub-type of adjusting particles.

It can be understood that, along the direction from the first end of one of the tenth sub-type of adjusting particles to the second end of one of the tenth sub-type of adjusting particles, the diameters of the second inscribed circles of the second cross-sectional surfaces of one of the tenth sub-type of adjusting particles gradually decrease, indicating that the diameters of the second inscribed circles of the second cross-sectional surfaces of one of the tenth sub-type of adjusting particles show a decreasing trend, including but not limited to the diameters of the second inscribed circles of the second cross-sectional surfaces of one of the tenth sub-type of adjusting particles decreasing sequentially.

In some embodiments, the second cross-sectional surfaces of one of the tenth sub-type of adjusting particles may be circular, elliptical, triangular, quadrilateral, or other regular or irregular shapes.

In some embodiments, the tenth sub-type of adjusting particles are long cone-shaped particles.

In some embodiments, when the tenth sub-type of adjusting particles are long cone-shaped particles, the second cross-sectional surfaces of one of the tenth sub-type of adjusting particles are circular or elliptical. Along the direction from the first end of one of the tenth sub-type of adjusting particles to the second end of one of the tenth sub-type of adjusting particles, shapes of the second cross-sectional surfaces of one of the tenth sub-type of adjusting particles are the same, and areas of the second cross-sectional surfaces of one of the tenth sub-type of adjusting particles gradually decrease. When the second cross-sectional surfaces of one of the tenth sub-type of adjusting particles are elliptical, a ratio of a major axis of an ellipse (the shape of each of the second cross-sectional surfaces of one of the tenth sub-type of adjusting particles) to a minor axis of the ellipse is greater than 1 and less than or equal to 3, for example, 1.2, 1.5, 1.8, 2, 2.2, 2.5, 2.8, or the like.

In some embodiments, compared to the eighth sub-type of adjusting particles, the ninth sub-type of adjusting particles, and the tenth sub-type of adjusting particles, the sixth sub-type of adjusting particles and the seventh sub-type of adjusting particles have a better improvement effect on the optical properties of the polarizer 100. Therefore, preferably, the adjusting particles 104 include the sixth sub-type of adjusting particles, the seventh sub-type of adjusting particles, or both of them. More preferably, the second type of adjusting particles 106 are composed of the seventh sub-type of adjusting particles, the sixth sub-type of adjusting particles, or both of them.

In some embodiments, the length of the major axis of one of the second type of adjusting particles 106 is less than or equal to 30 microns, for example, 1 micron, 1.5 microns, 2 microns, 2.5 microns, 3 microns, 3.5 microns, 4 microns, 4.5 microns, 5 microns, 8 microns, 10 microns, 12 microns, 15 microns, 16 microns, 18 microns, 20 microns, 22 microns, 23 microns, 24 microns, 25 microns, 26 microns, 28 microns, or the like, to better disperse in the first adhesive layer 107 and effectively enhance the color viewing angle of the polarizer 100.

In some embodiments, the diameter of the second inscribed circle with the largest diameter among the plurality of second inscribed circles of each of the second type of adjusting particles 106 is less than or equal to 5 microns, for example, 0.5 microns, 1 micron, 1.5 microns, 2 microns, 2.5 microns, 3 microns, 3.5 microns, 4 microns, 4.5 microns, or the like. Furthermore, the diameter of the second inscribed circle with the largest diameter among the plurality of second inscribed circles of each of the second type of adjusting particles 106 is greater than or equal to 1 micron.

In some embodiments, the adjusting particles 104 include the first type of adjusting particles 105 and the second type of adjusting particles 106, which is conducive to enhancing the improvement effect on the color viewing angle and the contrast of the polarizer 100, and improving the display quality of the display device including the polarizer 100.

In some embodiments, the first type of adjusting particles 105 are selected from at least two of the first sub-type of adjusting particles, the second sub-type of adjusting particles, the third sub-type of adjusting particles, the fourth sub-type of adjusting particles, and the fifth sub-type of adjusting particles. For example, the first type of adjusting particles 105 are mixtures of the first sub-type of adjusting particles, the second sub-type of adjusting particles, and the third sub-type of adjusting particles, mixtures of the first sub-type of adjusting particles, the fourth sub-type of adjusting particles, and the fifth sub-type of adjusting particles, or mixtures of the first sub-type of adjusting particles, the second sub-type of adjusting particles, the third sub-type of adjusting particles, the fourth sub-type of adjusting particles, and the fifth sub-type of adjusting particles. By adding the first type of adjusting particles 105 selected from at least two types of particles with different shapes, increasing the diversity of the shapes of the first type of adjusting particles 105, improving the optical anisotropy of the first type of adjusting particles 105, and enhancing the improvement effect of the first type of adjusting particles 105 on contrast and brightness. When the first type of adjusting particles 105 are the mixtures of the first sub-type of adjusting particles, the second sub-type of adjusting particles, and the third sub-type of adjusting particles, the mixtures of the first sub-type of adjusting particles, the fourth sub-type of adjusting particles, and the fifth sub-type of adjusting particles, or the mixtures of the first sub-type of adjusting particles, the second sub-type of adjusting particles, the third sub-type of adjusting particles, the fourth sub-type of adjusting particles, and the fifth sub-type of adjusting particles, the first sub-type of adjusting particles in the first sub-type of adjusting particles 105 have a mass percentage of 1% to 8%, for example, 1.5%, 2%, 2.5%, 3%, 3.5%, 4%, 4.5%, 5%, 6%, 6.5%, 7%, 7.5%, or the like; the second sub-type of adjusting particles, the fourth sub-type of adjusting particles, or both of them, in the first type of adjusting particles 105, have a mass percentage of 40% to 50%, for example, 41%, 42%, 43%, 44%, 45%, 46%, 47%, 48%, 49%, or the like; the third sub-type of adjusting particles, the fifth sub-type of adjusting particles, or both of them, in the first type of adjusting particles 105, have a mass percentage of 45% to 55%, for example, 46%, 47%, 48%, 49%, 50%, 51%, 52%, 53%, 54%, or the like. By mixing the first sub-type of adjusting particles, the second sub-type of adjusting particles and/or the fourth sub-type of adjusting particles, and the third sub-type of adjusting particles and/or the fifth sub-type of adjusting particles in the above range of mass percentage, it is conducive to further enhancing the improvement effect of the adjusting particles 104 on contrast and brightness.

In some embodiments, the adjusting particles 104 in the adhesive layer 103 have a mass percentage less than or equal to 20%, for example, 0.0001%, 0.001%, 0.01%, 0.02%, 0.05%, 0.1%, 0.5%, 1%, 5%, 8%0, 1, 12%, 15%, 18%, or the like, to facilitate the dispersion of the adjusting particles 104 in the adhesive layer 103 and improve the display quality of the display device including the polarizer 100. The adjusting particles 104 with a smaller mass percentage in the adhesive layer 103 can effectively improve the optical properties of the polarizer 100 in terms of color viewing angle and contrast, and the smaller the mass percentage, the better the dispersibility. Preferably, the adjusting particles 104 in the first adhesive layer 107 have the mass percentage less than or equal to 10%. More preferably, the adjusting particles 104 in the adhesive layer 103 have the mass percentage less than or equal to 5%. Most preferably, the adjusting particles 104 in the adhesive layer 103 have the mass percentage less than or equal to 1%. Further preferably, the adjusting particles 104 in the adhesive layer 103 have the mass percentage less than or equal to 0.05%. Moreover, in order to ensure that the amount of the adjusting particles 104 in the adhesive layer 103 is sufficient to effectively improve the optical properties of the polarizer 100, the adjusting particles 104 in the adhesive layer 103 have the mass percentage greater than or equal to 0.001%, preferably greater than or equal to 0.003%, more preferably greater than or equal to 0.005%, most preferably greater than or equal to 0.015%, and further preferably greater than or equal to 0.03%.

In some embodiments, a difference between a refractive index of the adhesive layer 103 and a refractive index of the adjusting particles 104 is greater than or equal to 0.02, for example, 0.03, 0.05, 0.09, 0.1, 0.15, 0.2, or the like, to facilitate achieving the optical diffusion function of the adjusting particles 104 and further improve the optical properties of the polarizer 100. Preferably, the difference between the refractive index of the adhesive layer 103 and the refractive index of the adjusting particles 104 is greater than or equal to 0.1, for example, 0.12, 0.13, 0.14, 0.15, 0.2, or the like. Exemplarily, when the adjusting particles 104 are dispersed in the first adhesive sub-layer 110, a difference between the refractive index of the adjusting particles 104 and a refractive index of the first adhesive sub-layer 110 is greater than or equal to 0.02, preferably greater than or equal to 0.1. When the adjusting particles 104 are further dispersed in the third adhesive sub-layer 112, a difference between the refractive index of the adjusting particles 104 and a refractive index of the third adhesive sub-layer 112 is greater than or equal to 0.02, preferably greater than or equal to 0.1. When the adjusting particles 104 are further dispersed in the second adhesive sub-layer 111, a difference between the refractive index of the adjusting particles 104 and a refractive index of the second adhesive sub-layer 111 is greater than or equal to 0.02, preferably greater than or equal to 0.1. When the adjusting particles 104 are further dispersed in the fourth adhesive sub-layer 113, a difference between the refractive index of the adjusting particles 104 and a refractive index of the fourth adhesive sub-layer 113 is greater than or equal to 0.02, preferably greater than or equal to 0.1. When the adjusting particles 104 are also dispersed in at least one adhesive sub-layer (such as the seventh adhesive sub-layer) between the first adhesive sub-layer 110 and the third adhesive sub-layer 112, a difference between the refractive index of the adjusting particles 104 and a refractive index of the at least one adhesive sub-layer between the first adhesive sub-layer 110 and the third adhesive sub-layer 112 is greater than or equal to 0.02, preferably greater than or equal to 0.1.

In some embodiments, the first type of adjusting particles 105 and the second type of adjusting particles 106 are crystal whiskers. The materials of the second type of adjusting particles 106 and the first type of adjusting particles 105 are independently selected from at least one of polystyrene (PS), polyethylene, polypropylene, silicon dioxide, zirconia, magnesium carbonate, magnesium sulfate, barium carbonate, barium sulfate, silicon carbide, silicon nitride, zinc oxide, magnesium oxide, aluminum oxide, calcium sulfate, calcium carbonate, potassium titanate, and aluminum borate.

In some embodiments, surface modification may be carried out on the first type of adjusting particles 105, the second type of adjusting particles 106, or both of them, to improve the dispersibility of the first type of adjusting particles 105, the second type of adjusting particles 106, or both of them in the first adhesive layer 107, or to enhance the toughness and other functional properties of the first type of adjusting particles 105, the second type of adjusting particles 106, or both of them. When the surface modification is carried out on the first type of adjusting particles 105, the second type of adjusting particles 106, or both of them, surfaces of the first type of adjusting particles 105, surfaces of the second type of adjusting particles 106, or both of them are modified by at least one of inorganic cations, inorganic anions, polymers, coupling agents, and surfactants. That is, the surfaces of the first type of adjusting particles 105, the surfaces of the second type of adjusting particles 106, or both of them include at least one of inorganic cation groups, inorganic anion groups, polymer groups, coupling agent groups, and surfactant groups.

Specifically, the surfaces of the first type of adjusting particles 105, the surfaces of the second type of adjusting particles 106, or both of them are modified by at least one selected from magnesium chloride, calcium chloride, barium chloride, strontium chloride, stearic acid, sodium stearate, zinc octadecanoate, sulfonic acid-based surfactants, thio-based surfactants, titanate, aluminate, polyacrylamide, silane, alkyl phosphate ester, aryl phosphate ester, alkyl phosphate, aryl phosphate, alkyl alcohol amide phosphate ester, alkyl alcohol amide phosphate, imidazoline phosphate ester, imidazoline phosphate, high polymer phosphate ester, high polymer phosphate, and siloxane phosphate ester. Preferably, the surfaces of the first type of adjusting particles 105, the surfaces of the second type of adjusting particles 106, or both of them are modified by at least one of sulfonic acid-based surfactants and thio-based surfactants. The sulfonic acid-based surfactant may be selected from at least one of alkyl sulfonate and fluorinated alkyl sulfonate, for example, at least one of sodium dodecyl sulfonate, sodium dodecylbenzene sulfonate, and sodium fluorododecyl sulfonate. The thio-based surfactant may be selected from at least one of thiol and fluorothiol, for example, at least one of octanethiol, dodecanethiol, tetradecanethiol, octadecanethiol, fluorooctanethiol, and fluorododecanethiol. After the sulfonic acid-based surfactants are mixed with the regulating particles 104 to be surface-modified, the sulfonic acid-based surface-active groups form a sulfonic acid-based shell layer on the surfaces of the whiskers, such as a phenylsulfonic acid-based shell layer, or the like, which is conducive to protecting the regulating particles 104, enhancing the toughness of the regulating particles 104, and reducing the fracture of the first type regulating particles 105, the second type regulating particles 106, or both of them in the polarizer 100. After the thio-based surface-active groups are mixed with the regulating particles 104 to be surface-modified, the thio-based surface-active groups and hydroxyl groups on the surfaces of the whiskers form an O—S—O cross-linked network. The larger bond energy of O—S—O is conducive to protecting the first type of adjusting particles 105, the second type of adjusting particles 106, or both of them in the process of mixing the material of the first type of adjusting particles 105 and/or the material of the second type of adjusting particles 106 with the material of the first adhesive layer 107 to form the first adhesive layer 107, reducing the fracture of the first type of adjusting particles 105, the second type of adjusting particles 106, or both of them, and enhancing the improvement effect of the first type of adjusting particles 105, the second type of adjusting particles 106, or both of them on contrast and brightness. More preferably, the surfaces of the first type of adjusting particles 105, the surfaces of the second type of adjusting particles 106, or both of them are modified by at least one of sulfonic acid-based surfactants containing fluorine-containing substituent groups and thio-based surfactants containing fluorine-containing substituent groups, for example, at least one of sodium fluorododecyl sulfonate, fluorooctanethiol, and fluorododecanethiol. Due to the high stability of fluorine atoms in alkyl chains, the bond energy of the carbon-fluorine bond is higher than the bond energy of the carbon-carbon bond, and the carbon-fluorine bond has a shielding effect on the carbon-carbon bond, which is conducive to protecting the carbon-carbon bond, thereby enhancing the stability of the first type regulating particles 105, the second type regulating particles 106, or both of them.

In some embodiments, the polarizing layer 101 is made of polyvinyl alcohol and dyes.

In some embodiments, the material of the first protective layer 102, the material of the second protective layer 108, or both of them is selected from at least one of modified or unmodified polyester, or modified or unmodified cellulose acetate.

In some embodiments, the modified or unmodified polyester includes at least one of modified or unmodified polyethylene terephthalate, modified or unmodified polycarbonate, modified or unmodified polymethyl methacrylate, or modified or unmodified polyethylene naphthalate. The modified or unmodified cellulose acetate includes modified or unmodified cellulose triacetate.

In some embodiments, the first protective layer 102, the second protective layer 108, or both of them includes a first base material, a second base material, or both of them. The first base material may be selected from at least one of unmodified polyester and unmodified cellulose acetate. The second base material may be selected from at least one of modified polyester and modified cellulose acetate. In the first protective layer 102, the second protective layer 108, or both of them, a mass percentage of the first base material is greater than a mass percentage of the second base material.

In some embodiments, the first base material and the second base material are uniformly mixed with each other, and the first base material in the first protective layer 102 has a mass percentage greater than or equal to 65%, for example, 70%, 75%, 80%, 85%, 90%, 95%, 99%, or the like. The second base material in the first protective layer 102 has a mass percentage less than or equal to 35%, for example, 1%, 5%, 10%, 15%, 20%, 25%, 30%, or the like. It is beneficial for modified polyester such as polyethylene terephthalate to have good mutual solubility with unmodified polyester such as polyethylene terephthalate, or for modified cellulose acetate to have good mutual solubility with unmodified cellulose acetate such as triacetate cellulose, which is conducive to improving the mechanical performance, flatness, and crystallinity of the first protective layer 102.

In some embodiments, modified cellulose triacetate, modified polyethylene terephthalate, modified polycarbonate, modified polymethyl methacrylate, or modified polyethylene naphthalate can be obtained by respectively carrying out hydrophilic modification or lipophilic modification on unmodified cellulose triacetate, unmodified polyethylene terephthalate, unmodified polycarbonate, unmodified polymethyl methacrylate or unmodified polyethylene naphthalate. For example, the modified polyethylene terephthalate can be obtained by introducing side chains of straight-chain alkyl, side chains of carboxyl, side chains of hydroxyl, or side chains of fluorine-containing groups into the unmodified polyethylene terephthalate; the modified polyethylene terephthalate can be obtained by introducing side chains of carboxyl, side chains of hydroxyl, or both of them into the unmodified polyethylene terephthalate; and the modified polyethylene terephthalate can be obtained by introducing groups such as —(CH₂)ₙ—OH—(CH₂)ₘ—COOH, or both of them into the phenyl group of the unmodified polyethylene terephthalate, in which n and m are both integers greater than or equal to 0 and less than or equal to 10.

In some embodiments, when the first base material is unmodified polyethylene terephthalate and the second base material is modified polyethylene terephthalate, it is beneficial for the modified polyethylene terephthalate to have good mutual solubility with the unmodified polyethylene terephthalate, which is conducive to improving the mechanical performance, the flatness, and the crystallinity of the first protective layer 102, the second protective layer 108, or both of them.

As illustrated in FIGS. 4 to 12, in some embodiments, the polarizer 100 further includes a first optical functional layer 116 disposed at a side of the first protective layer 102 away from the polarizing layer 101.

In some embodiments, the first optical functional layer 116 includes at least one of an anti-glare sub-layer, a transparent hardening sub-layer 117 (as illustrated in FIGS. 4 to 7), a low-reflection sub-layer 118, an anti-reflection sub-layer, an anti-fingerprint sub-layer, and an anti-static layer. As illustrated in FIGS. 8 to 12, when the first optical functional layer 116 is the low-reflection sub-layer 118, the low-reflection sub-layer 118 can be formed by stacking a transparent hardening part 119 and a low-refraction part 120.

As illustrated in FIGS. 1 to 3, in some embodiments, the polarizer 100 further includes a first release layer 121 disposed on a side of the first protective layer 102 away from the polarizing layer 101. The first release layer 121 is adhered to the first protective layer 102 through a first adhesive layer. When the polarizer 100 is provided with the first optical functional layer 116, the first release layer 121 is removed.

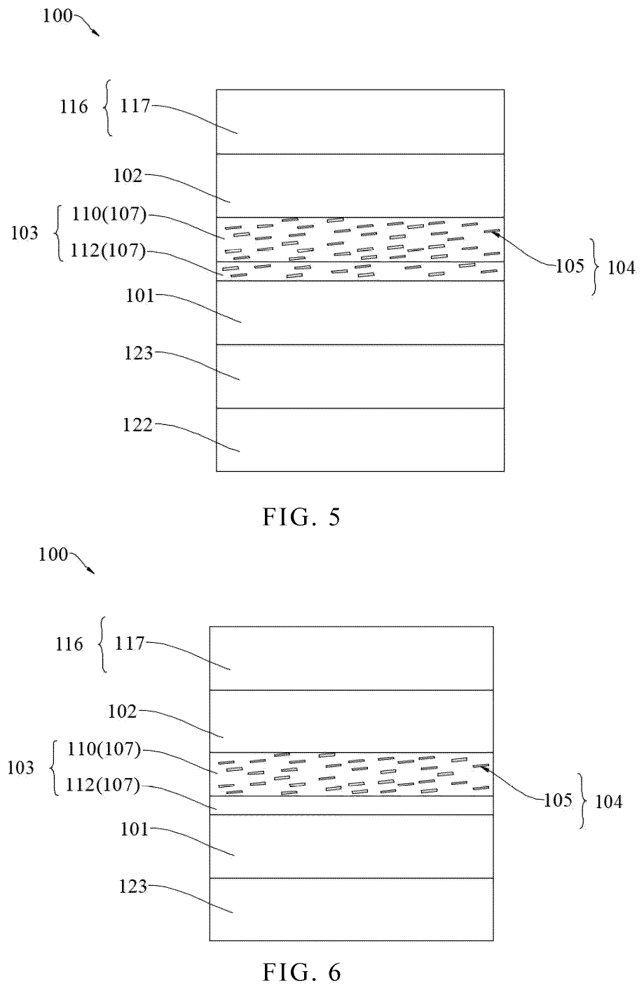

As illustrated in FIG. 5, in some embodiments, the polarizer 100 further includes a second release layer 122 disposed at a side of the polarizing layer 101 away from the first protective layer 102. The second release layer 122 is adhered to the polarizing layer 101 through a second adhesive layer. When the polarizer 100 is applied to the display device, the second release layer 122 is removed to expose the second adhesive layer, so that the polarizer 100 is adhered to the display panel in the display device through the second adhesive layer.

As illustrated in FIGS. 1 to 12, in some embodiments, the polarizer 100 further includes a compensation layer 123 disposed between the second adhesive layer and the polarizing layer 101.

By dispersing the adjusting particles 104 in the adhesive layer 103 between the polarizing layer 101 and the first protective layer 102, the embodiments of the disclosure improve the color viewing angle and the contrast of the polarizer 100, and enhance the display quality of the display device including the polarizer 100.

As illustrated in FIG. 13, some embodiments of the disclosure further provide a display device 10 including the polarizer 100 as discussed above.

In some embodiments, the display device 10 includes a display panel 200 and a first polarizer 300 disposed on a light-emitting side of the display panel 200, and the first polarizer 300 is the polarizer 100 as discussed above.

In some embodiments, the display panel 200 may be a liquid crystal display panel, a self-luminous display panel, or the like. The self-luminous display panel may be an organic light-emitting diode (OLED) display panel, or the like.

In some embodiments, optical films in the first polarizer 300 is disposed at a side of the polarizing layer 101 in the first polarizer 300 away from the display panel 200.

In some embodiments, when the display panel 200 is a liquid crystal display panel, the display device 10 further includes a backlight module 400 disposed at a side of the display panel 200 away from the first polarizer 300, and the backlight module 400 is used to provide a light source for the display panel 200. The display device 10 further includes a second polarizer 500 disposed between the backlight module 400 and the display panel 200. The second polarizer 500 may have the same structure as the polarizer 100 as described in any of the above embodiments.

The disclosure will be described in detail with reference to some specific examples in the following. It can be understood that these examples are provided for illustration purposes only and should not be construed in any way as limiting the disclosure.

### Example 1

In this example, the first adhesive sub-layer 110 and the third adhesive sub-layer 112 in the first adhesive layer 107 are both made of commercially available pressure-sensitive adhesives. The adjusting particles 104 in the first adhesive sub-layer 110 and the third adhesive sub-layer 112 are rod-shaped calcium carbonate, and the adjusting particles 104 are dispersed in the first adhesive sub-layer 110 with a thickness of 25 microns and the third adhesive sub-layer 112 with a thickness of 5 microns, and the first adhesive sub-layer 110 and the third adhesive sub-layer 112 form an adhesive layer 1. The adjusting particles 104 in the adhesive layer 1 has 7% by mass on the basis of the adhesive layer.

### Example 2

This example is similar to the example 1, the difference is in that the adjusting particles 104 are dispersed in the first adhesive sub-layer 110 and not dispersed in the third adhesive sub-layer 112, which together form an adhesive layer 2.

### Example 3

This example is similar to the example 1, the difference is in that the first adhesive layer 107 consists of the first adhesive sub-layer 110 with a thickness of 30 microns to form an adhesive layer 3.

### Example 4

This example is similar to the example 1, the difference is in that the first adhesive layer 107 further includes the fifth adhesive sub-layer 114, which is made of commercially available UV-curing adhesive. The fifth adhesive sub-layer 114 has a thickness of 1 micron and the third adhesive sub-layer 112 has a thickness of 4 microns, and the first adhesive sub-layer 110, the third adhesive sub-layer 112, and the fifth adhesive sub-layer 114 form an adhesive layer 4.

### Example 5

This example is similar to the example 4, the difference is in that the shape of the adjusting particles 104 is cubic to form an adhesive layer 5.

### Example 6

This example is similar to the example 4, the difference is in that the shape of the adjusting particles 104 is spherical to form an adhesive layer 6.

### Example 7

This example is similar to the example 3, the difference is in that the first adhesive sub-layer 110 is made of commercially available UV-curing adhesive and has a thickness of 2 microns to form an adhesive layer 7.

### Comparative Example 1

This comparative example 1 is similar to the example 4, the difference is in that the adjusting particles 104 are not dispersed in the first adhesive layer 107, forming a comparative adhesive layer 1.

The adhesive layers 1-7 obtained from the examples 1-7 and the comparative adhesive layer 1 obtained from the comparative example 1 were placed between the polarizing layer and the first protective layer, respectively, and the polarizers were attached to a surface of the 75-inch liquid crystal display panel for further optical effect testing. The results are shown in Table 2. Each of the polarizers to be tested includes the compensation layer, the polarizing layer, the adhesive layer, the first protective layer, and the transparent hardening sub-layer sequentially laminated.

The contrast represents a ratio of brightness of the display panel in the dark state at a viewing angle of 60° to brightness at the center of the display panel in the dark state (calculated by taking the brightness at the center of the display panel in the dark state as 1).

The color viewing angle is measured according to the Cesi standard (CESI 0.03).

TABLE 2

| | Contrast | Color viewing angle/° |
|---|---|---|
| Adhesive layer 1 | 1.9 | 165 |
| Adhesive layer 2 | 1.9 | 170 |
| Adhesive layer 3 | 2.2 | 153 |
| Adhesive layer 4 | 1.9 | 168 |
| Adhesive layer 5 | 2.1 | 140 |
| Adhesive layer 6 | 2.1 | 142 |
| Adhesive layer 7 | 3.5 | 84 |
| Comparative | 4.2 | 92 |
| adhesive layer 1 | | |

As can be seen from Table 2, by setting the adjusting particles dispersed in the adhesive layer, it can significantly improve the contrast of the polarizer. When the adhesive sub-layer with the adjusting particles is made from pressure-sensitive adhesives, the color viewing angle can be significantly improved. Moreover, compared to the cubic and spherical adjusting particles with smaller length-diameter ratios, the use of the rod-shaped particles with larger length-diameter ratios can significantly improve the optical properties of the polarizer in terms of the contrast and the color viewing angle. In addition, compared to the adjusting particles dispersed in a single adhesive sub-layer made of pressure-sensitive adhesives, when a total thickness of multiple adhesive sub-layers made of pressure-sensitive adhesives remains unchanged, when the adjusting particles are dispersed in multiple adhesive sub-layers made of pressure-sensitive adhesives, it can significantly enhance the improvement effect on the optical properties (such as the contrast and the color viewing angle) of the polarizer.

This disclosure provides a detailed description to the polarizer and the display device containing the polarizer in the embodiments of the disclosure. In this context, specific embodiments are used to illustrate the principles and core ideas of the disclosure. The description of the above-mentioned embodiments is only used to help understand the core ideas of the disclosure. At the same time, for those skilled in the art, according to the core ideas of the disclosure, there might be changes in specific embodiments and the scope of the disclosure, which fall within the scope of the protection of the disclosure. Based on the above, the content of this specification should not be understood as limitations on the disclosure.

What is claimed is:

1. A polarizer comprising:
a polarizing layer;
a first protective layer disposed on a side of the polarizing layer;
an adhesive layer disposed between the polarizing layer and the first protective layer; and
adjusting particles dispersed in the adhesive layer,
wherein the adjusting particles comprise:
first type of adjusting particles, wherein one of the first type of adjusting particles comprises a plurality of first cross-sectional surfaces, each of the first cross-sectional surfaces has a first inscribed circle, and a ratio of a length of a major axis of one of the first type of adjusting particles to a diameter of the first inscribed circle with a largest diameter among a plurality of the first inscribed circles is greater than or equal to 5 and less than or equal to 50; and/or
second type of adjusting particles, wherein one of the second type of adjusting particles comprises a plurality of second cross-sectional surfaces, each of the second cross-sectional surfaces has a second inscribed circle, and a ratio of a length of a major axis of one of the second type of adjusting particles to a diameter of the second inscribed circle with a largest diameter among a plurality of the second inscribed circles is greater than or equal to 1 and less than 5.

2. The polarizer of claim 1, wherein the adhesive layer comprises a first adhesive layer disposed between the first protective layer and the polarizing layer, and the adjusting particles are dispersed in the first adhesive layer; or
wherein the polarizer further comprises a second protective layer disposed between the first protective layer and the polarizing layer; the adhesive layer comprises a first adhesive layer and a second adhesive layer, the first adhesive layer is disposed between the second protective layer and the polarizing layer, the second adhesive layer is disposed between the first protective layer and the second protective layer, and the adjusting particles are dispersed in the first adhesive layer, the second adhesive layer or both of them.

3. The polarizer of claim 1, wherein the adhesive layer comprises a first adhesive layer disposed between the first protective layer and the polarizing layer, and the adjusting particles are dispersed in the first adhesive layer; and the first adhesive layer comprises a first adhesive sub-layer, and the adjusting particles in the first adhesive layer are dispersed at least in the first adhesive sub-layer; and/or
wherein the polarizer further comprises a second protective layer disposed between the first protective layer and the polarizing layer; the adhesive layer comprises the first adhesive layer and a second adhesive layer, the first adhesive layer is disposed between the second protective layer and the polarizing layer, and the second adhesive layer is disposed between the first protective layer and the second protective layer; and the second adhesive layer comprises a second adhesive sub-layer, and the adjusting particles in the second adhesive layer are dispersed at least in second adhesive sub-layer.

4. The polarizer of claim 1, wherein the adhesive layer comprises a first adhesive layer disposed between the first protective layer and the polarizing layer, the first adhesive layer comprises a first adhesive sub-layer and a third adhesive sub-layer disposed at a side of the first adhesive sub-layer close to the polarizing layer, and the adjusting particles in the first adhesive layer are dispersed in the first adhesive sub-layer and the third adhesive sub-layer; and/or
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; and the second adhesive layer comprises a second adhesive sub-layer and a fourth adhesive sub-layer disposed at a side of the second adhesive sub-layer close to the polarizing layer, and the adjusting particles in the second adhesive layer are dispersed in the second adhesive sub-layer and the fourth adhesive sub-layer.

5. The polarizer of claim 1, wherein the adhesive layer comprises a first adhesive layer disposed between the first protective layer and the polarizing layer, the first adhesive layer comprises a first adhesive sub-layer and a third adhesive sub-layer disposed at a side of the first adhesive sub-layer close to the polarizing layer, and the adjusting particles in the first adhesive layer are dispersed in the first adhesive sub-layer and the third adhesive sub-layer; and both of a material of the first adhesive sub-layer and a material of the third adhesive sub-layer are pressure-sensitive adhesives; and/or,
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; and the second adhesive layer comprises a second adhesive sub-layer and a fourth adhesive sub-layer disposed at a side of the second adhesive sub-layer close to the polarizing layer, and the adjusting particles in the second adhesive layer are dispersed in the second adhesive sub-layer and the fourth adhesive sub-layer; and
both of a material of the second adhesive sub-layer and a material of the fourth adhesive sub-layer are pressure-sensitive adhesives.

6. The polarizer of claim 1, wherein the adhesive layer comprises a first adhesive layer disposed between the first protective layer and the polarizing layer; the first adhesive layer comprises a first adhesive sub-layer, a third adhesive sub-layer, and a fifth adhesive layer, the third adhesive sub-layer is disposed at a side of the first adhesive sub-layer close to the polarizing layer, and the fifth adhesive layer is disposed at a side of the third adhesive sub-layer close to the polarizing layer; and the adjusting particles in the first adhesive layer are dispersed in the first adhesive sub-layer and the third adhesive sub-layer, and not dispersed in the fifth adhesive layer; and/or
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; the second adhesive layer comprises a second adhesive sub-layer, a fourth adhesive sub-layer, and a sixth adhesive sub-layer, the fourth adhesive sub-layer is disposed at a side of the second adhesive sub-layer close to the polarizing layer, and the sixth adhesive sub-layer is disposed at a side of the fourth adhesive sub-layer close to the polarizing layer; and the adjusting particles in the second adhesive layer are dispersed in the second adhesive sub-layer and the fourth adhesive sub-layer, and not dispersed in the sixth adhesive sub-layer.

7. The polarizer of claim 1, wherein the first protective layer comprises a first hydrophilic sub-layer disposed close to the polarizing layer, the adhesive layer comprises a first adhesive layer disposed between the polarizing layer and the first protective layer, the adjusting particles are dispersed in the first adhesive layer, and a peeling force between the first adhesive layer and the first hydrophilic sub-layer is greater than a peeling force between the first adhesive layer and the polarizing layer; or
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; and the adjusting particles are dispersed in the second adhesive layer, and a peeling force between the second adhesive layer and the first hydrophilic sub-layer is greater than a peeling force between the second adhesive layer and the second protective layer.

8. The polarizer of claim 1, wherein the first type of adjusting particles are selected from at least one of first sub-type of adjusting particles, second sub-type of adjusting particles, third sub-type of adjusting particles, fourth sub-type of adjusting particles, and fifth sub-type of adjusting particles with different shapes; and the second type of adjusting particles are selected from at least one of sixth sub-type of adjusting particles, seventh sub-type of adjusting particles, eighth sub-type of adjusting particles, ninth sub-type of adjusting particles, and tenth sub-type of adjusting particles with different shapes;
a variation value of the diameters of the first inscribed circles of the first cross-sectional surfaces of one of the first sub-type of adjusting particles along an extension direction of a major axis of one of the first sub-type of adjusting particles is less than or equal to 0.3 microns;
a variation value of the diameters of the first inscribed circles of the first cross-sectional surfaces of a middle part of one of the second sub-type of adjusting particles along an extension direction of a major axis of one of the second sub-type of adjusting particles is less than or equal to 1 micron; and along a direction away from the middle part of one of the second sub-type of adjusting particles, the diameters of the first inscribed circles of the first cross-sectional surfaces of a first end of one of the second sub-type of adjusting particles gradually decrease, and a change value of the diameters of the first inscribed circles of the first cross-sectional surfaces of a second end of one of the second sub-type of adjusting particles is less than or equal to 1 micron;
a variation value of the diameters of the first inscribed circles of the first cross-sectional surfaces of a middle part of one of the third sub-type of adjusting particles along an extension direction of a major axis of one of the third sub-type of adjusting particles is less than or equal to 1 micron; and along a direction away from the middle part of one of the third sub-type of adjusting particles, the diameters of the first inscribed circles of the first cross-sectional surfaces of a first end of one of the third sub-type of adjusting particles gradually decrease, and the diameters of the first inscribed circles of the first cross-sectional surfaces of a second end of one of the third sub-type of adjusting particles gradually decrease;
a first end of one of the fourth sub-type of adjusting particles is connected to a second end of one of the fourth sub-type of adjusting particles, and the diameters of the first inscribed circles of the first cross-sectional surfaces of one of the fourth sub-type of adjusting particles gradually decrease along a direction from the first end of one of the fourth sub-type of adjusting particles to the second end of one of the fourth sub-type of adjusting particles;
a first end of one of the fifth sub-type of adjusting particles is connected to a second end of one of the fifth sub-type of adjusting particles, the diameters of the first inscribed circles of the first cross-sectional surfaces of the first end of one of the fifth sub-type of adjusting particles gradually decrease along a direction away from the second end of one of the fifth sub-type of adjusting particles, and the diameters of the first inscribed circles of the first cross-sectional surfaces of the second end of one of the fifth sub-type of adjusting particles gradually decrease along a direction away from the first end of one of the fifth sub-type of adjusting particles;
a variation value of the diameters of the second inscribed circles of the second cross-sectional surfaces of one of the sixth sub-type of adjusting particles along an extension direction of a major axis of one of the sixth sub-type of adjusting particles is less than or equal to 0.3 microns;
a first end of one of the seventh sub-type of adjusting particles is connected to a second end of one of the seventh sub-type of adjusting particles, the diameters of the second inscribed circles of the second cross-sectional surfaces of the first end of one of the seventh sub-type of adjusting particles gradually decrease along a direction away from the second end of one of the seventh sub-type of adjusting particles, and the diameters of the second inscribed circles of the second cross-sectional surfaces of the second end of one of the seventh sub-type of adjusting particles gradually decrease along a direction away from the first end of one of the seventh sub-type of adjusting particles;
a variation value of the diameters of the second inscribed circles of the second cross-sectional surfaces of a middle part of one of the eighth sub-type of adjusting particles along an extension direction of a major axis of one of the eighth sub-type of adjusting particles is less than or equal to 1 micron; and along a direction away from the middle part of one of the eighth sub-type of adjusting particles, the diameters of the second inscribed circles of the second cross-sectional surfaces of a first end of one of the eighth sub-type of adjusting particles gradually decrease, and a variation value of the diameters of the second inscribed circles of the second cross-sectional surfaces of a second end of one of the eighth sub-type of adjusting particles is less than or equal to 1 micron;
a variation value of the diameters of the second inscribed circles of the second cross-sectional surfaces of a middle part of one of the ninth sub-type of adjusting particles along an extension direction of a major axis of one of the ninth sub-type of adjusting particles is less than or equal to 1 micron; and along a direction away from the middle part of one of the ninth sub-type of adjusting particles, the diameters of the second inscribed circles of the second cross-sectional surfaces of a first end of one of the ninth sub-type of adjusting particles gradually decrease, and the diameters of the second inscribed circles of the second cross-sectional surfaces of a second end of one of the ninth sub-type of adjusting particles gradually decrease; and
a first end of one of the tenth sub-type of adjusting particles is connected to a second end of one of the tenth sub-type of adjusting particles, and the diameters of the second inscribed circles of the second cross-sectional surfaces of one of the tenth sub-type of adjusting particles gradually decrease along a direction from the first end of one of the tenth sub-type of adjusting particles to the second end of one of the tenth sub-type of adjusting particles.

9. The polarizer of claim 1, wherein the polarizer further comprises a first optical functional layer disposed on a side of the first protective layer, wherein the first optical functional layer comprises at least one of an anti-glare sub-layer, a transparent hardening sub-layer, a low-reflection sub-layer, an anti-reflection sub-layer, an anti-fingerprint sub-layer, and an anti-static sub-layer; and
wherein the first optical functional layer is disposed at a side of the first protective layer away from the polarizing layer.

10. A display device comprising a polarizer, wherein the polarizer comprises:
a polarizing layer;
a first protective layer disposed on a side of the polarizing layer;
an adhesive layer disposed between the polarizing layer and the first protective layer; and
adjusting particles dispersed in the adhesive layer,
wherein the adjusting particles comprise:
first type of adjusting particles, wherein one of the first type of adjusting particles comprises a plurality of first cross-sectional surfaces, each of the first cross-sectional surfaces has a first inscribed circle, and a ratio of a length of a major axis of one of the first type of adjusting particles to a diameter of the first inscribed circle with a largest diameter among a plurality of the first inscribed circles is greater than or equal to 5 and less than or equal to 50; and/or
second type of adjusting particles, wherein one of the second type of adjusting particles comprises a plurality of second cross-sectional surfaces, each of the second cross-sectional surfaces has a second inscribed circle, and a ratio of a length of a major axis of one of the second type of adjusting particles to a diameter of the second inscribed circle with a largest diameter among a plurality of the second inscribed circles is greater than or equal to 1 and less than 5.

11. The display device of claim 10, wherein the adhesive layer comprises a first adhesive layer disposed between the first protective layer and the polarizing layer, and the adjusting particles are dispersed in the first adhesive layer; or
wherein the polarizer further comprises a second protective layer disposed between the first protective layer and the polarizing layer; the adhesive layer comprises a first adhesive layer and a second adhesive layer, the first adhesive layer is disposed between the second protective layer and the polarizing layer, the second adhesive layer is disposed between the first protective layer and the second protective layer, and the adjusting particles are dispersed in the first adhesive layer, the second adhesive layer, or both of them.

12. The display device of claim 10, wherein the adhesive layer comprises a first adhesive layer disposed between the first protective layer and the polarizing layer, and the adjusting particles are dispersed in the first adhesive layer; and the first adhesive layer comprises a first adhesive sub-layer, and the adjusting particles in the first adhesive layer are dispersed at least in the first adhesive sub-layer; and/or
wherein the polarizer further comprises a second protective layer disposed between the first protective layer and the polarizing layer; the adhesive layer comprises the first adhesive layer and a second adhesive layer, the first adhesive layer is disposed between the second protective layer and the polarizing layer, and the second adhesive layer is disposed between the first protective layer and the second protective layer; and the second adhesive layer comprises a second adhesive sub-layer, and the adjusting particles in the second adhesive layer are dispersed at least in second adhesive sub-layer.

13. The display device of claim 10, wherein the adhesive layer comprises a first adhesive layer disposed between the first protective layer and the polarizing layer, the first adhesive layer comprises a first adhesive sub-layer and a third adhesive sub-layer disposed at a side of the first adhesive sub-layer close to the polarizing layer, and the adjusting particles in the first adhesive layer are dispersed in the first adhesive sub-layer and the third adhesive sub-layer; and/or
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; and the second adhesive layer comprises a second adhesive sub-layer and a fourth adhesive sub-layer disposed at a side of the second adhesive sub-layer close to the polarizing layer, and the adjusting particles in the second adhesive layer are dispersed in the second adhesive sub-layer and the fourth adhesive sub-layer.

14. The display device of claim 10, wherein the adhesive layer comprises a first adhesive layer disposed between the first protective layer and the polarizing layer, the first adhesive layer comprises a first adhesive sub-layer and a third adhesive sub-layer disposed at a side of the first adhesive sub-layer close to the polarizing layer, and the adjusting particles in the first adhesive layer are dispersed in the first adhesive sub-layer and the third adhesive sub-layer; and both of a material of the first adhesive sub-layer and a material of the third adhesive sub-layer are pressure-sensitive adhesives; and/or,
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; and the second adhesive layer comprises a second adhesive sub-layer and a fourth adhesive sub-layer disposed at a side of the second adhesive sub-layer close to the polarizing layer, and the adjusting particles in the second adhesive layer are dispersed in the second adhesive sub-layer and the fourth adhesive sub-layer; and both of a material of the second adhesive sub-layer and a material of the fourth adhesive sub-layer are pressure-sensitive adhesives.

15. The display device of claim 10, wherein the adhesive layer comprises a first adhesive layer disposed between the first protective layer and the polarizing layer; the first adhesive layer comprises a first adhesive sub-layer, a third adhesive sub-layer, and a fifth adhesive layer, the third adhesive sub-layer is disposed at a side of the first adhesive sub-layer close to the polarizing layer, and the fifth adhesive layer is disposed at a side of the third adhesive sub-layer close to the polarizing layer; and the adjusting particles in the first adhesive layer are dispersed in the first adhesive sub-layer and the third adhesive sub-layer, and not dispersed in the fifth adhesive layer; and/or
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; the second adhesive layer comprises a second adhesive sub-layer, a fourth adhesive sub-layer, and a sixth adhesive sub-layer, the fourth adhesive sub-layer is disposed at a side of the second adhesive sub-layer close to the polarizing layer, and the sixth adhesive sub-layer is disposed at a side of the fourth adhesive sub-layer close to the polarizing layer; and the adjusting particles in the second adhesive layer are dispersed in the second adhesive sub-layer and the fourth adhesive sub-layer, and not dispersed in the sixth adhesive sub-layer.

16. The display device of claim 10, wherein the first protective layer comprises a first hydrophilic sub-layer disposed close to the polarizing layer, the adhesive layer comprises a first adhesive layer disposed between the polarizing layer and the first protective layer, the adjusting particles are dispersed in the first adhesive layer, and a peeling force between the first adhesive layer and the first hydrophilic sub-layer is greater than a peeling force between the first adhesive layer and the polarizing layer; or
wherein the polarizer further comprises a second protective layer disposed between the first protective layer and the polarizing layer, the adhesive layer comprises the first adhesive layer and a second adhesive layer, the first adhesive layer is disposed between the second protective layer and the polarizing layer, and the second adhesive layer is disposed between the first protective layer and the second protective layer; and the adjusting particles are dispersed in the second adhesive layer, and a peeling force between the second adhesive layer and the first hydrophilic sub-layer is greater than a peeling force between the second adhesive layer and the second protective layer.

17. The display device of claim 10, wherein the first type of adjusting particles are selected from at least one of first sub-type of adjusting particles, second sub-type of adjusting particles, third sub-type of adjusting particles, fourth sub-type of adjusting particles, and fifth sub-type of adjusting particles with different shapes; and
the second type of adjusting particles are selected from at least one of sixth sub-type of adjusting particles, seventh sub-type of adjusting particles, eighth sub-type of adjusting particles, ninth sub-type of adjusting particles, and tenth sub-type of adjusting particles with different shapes;
a variation value of the diameters of the first inscribed circles of the first cross-sectional surfaces of one of the first sub-type of adjusting particles along an extension direction of a major axis of one of the first sub-type of adjusting particles is less than or equal to 0.3 microns;
a variation value of the diameters of the first inscribed circles of the first cross-sectional surfaces of a middle part of one of the second sub-type of adjusting particles along an extension direction of a major axis of one of the second sub-type of adjusting particles is less than or equal to 1 micron; and along a direction away from the middle part of one of the second sub-type of adjusting particles, the diameters of the first inscribed circles of the first cross-sectional surfaces of a first end of one of the second sub-type of adjusting particles gradually decrease, and a change value of the diameters of the first inscribed circles of the first cross-sectional surfaces of a second end of one of the second sub-type of adjusting particles is less than or equal to 1 micron;
a variation value of the diameters of the first inscribed circles of the first cross-sectional surfaces of a middle part of one of the third sub-type of adjusting particles along an extension direction of a major axis of one of the third sub-type of adjusting particles is less than or equal to 1 micron; and along a direction away from the middle part of one of the third sub-type of adjusting particles, the diameters of the first inscribed circles of the first cross-sectional surfaces of a first end of one of the third sub-type of adjusting particles gradually decrease, and the diameters of the first inscribed circles of the first cross-sectional surfaces of a second end of one of the third sub-type of adjusting particles gradually decrease;
a first end of one of the fourth sub-type of adjusting particles is connected to a second end of one of the fourth sub-type of adjusting particles, and the diameters of the first inscribed circles of the first cross-sectional surfaces of one of the fourth sub-type of adjusting particles gradually decrease along a direction from the first end of one of the fourth sub-type of adjusting particles to the second end of one of the fourth sub-type of adjusting particles;
a first end of one of the fifth sub-type of adjusting particles is connected to a second end of one of the fifth sub-type of adjusting particles, the diameters of the first inscribed circles of the first cross-sectional surfaces of the first end of one of the fifth sub-type of adjusting particles gradually decrease along a direction away from the second end of one of the fifth sub-type of adjusting particles, and the diameters of the first inscribed circles of the first cross-sectional surfaces of the second end of one of the fifth sub-type of adjusting particles gradually decrease along a direction away from the first end of one of the fifth sub-type of adjusting particles;
a variation value of the diameters of the second inscribed circles of the second cross-sectional surfaces of one of the sixth sub-type of adjusting particles along an extension direction of a major axis of one of the sixth sub-type of adjusting particles is less than or equal to 0.3 microns;
a first end of one of the seventh sub-type of adjusting particles is connected to a second end of one of the seventh sub-type of adjusting particles, the diameters of the second inscribed circles of the second cross-sectional surfaces of the first end of one of the seventh sub-type of adjusting particles gradually decrease along a direction away from the second end of one of the seventh sub-type of adjusting particles, and the diameters of the second inscribed circles of the second cross-sectional surfaces of the second end of one of the seventh sub-type of adjusting particles gradually decrease along a direction away from the first end of one of the seventh sub-type of adjusting particles;
a variation value of the diameters of the second inscribed circles of the second cross-sectional surfaces of a middle part of one of the eighth sub-type of adjusting particles along an extension direction of a major axis of one of the eighth sub-type of adjusting particles is less than or equal to 1 micron; and along a direction away from the middle part of one of the eighth sub-type of adjusting particles, the diameters of the second inscribed circles of the second cross-sectional surfaces of a first end of one of the eighth sub-type of adjusting particles gradually decrease, and a variation value of the diameters of the second inscribed circles of the second cross-sectional surfaces of a second end of one of the eighth sub-type of adjusting particles is less than or equal to 1 micron;
a variation value of the diameters of the second inscribed circles of the second cross-sectional surfaces of a middle part of one of the ninth sub-type of adjusting particles along an extension direction of a major axis of one of the ninth sub-type of adjusting particles is less than or equal to 1 micron; and along a direction away from the middle part of one of the ninth sub-type of adjusting particles, the diameters of the second inscribed circles of the second cross-sectional surfaces of a first end of one of the ninth sub-type of adjusting particles gradually decrease, and the diameters of the second inscribed circles of the second cross-sectional surfaces of a second end of one of the ninth sub-type of adjusting particles gradually decrease; and
a first end of one of the tenth sub-type of adjusting particles is connected to a second end of one of the tenth sub-type of adjusting particles, and the diameters of the second inscribed circles of the second cross-sectional surfaces of one of the tenth sub-type of adjusting particles gradually decrease along a direction from the first end of one of the tenth sub-type of adjusting particles to the second end of one of the tenth sub-type of adjusting particles.

18. The display device of claim 10, wherein the polarizer further comprises a first optical functional layer disposed on a side of the first protective layer, wherein the first optical functional layer comprises at least one of an anti-glare sub-layer, a transparent hardening sub-layer, a low-reflection sub-layer, an anti-reflection sub-layer, an anti-fingerprint sub-layer, and an anti-static sub-layer; and
wherein the first optical functional layer is disposed at a side of the first protective layer away from the polarizing layer.
